(19) United States
(12) Patent Application Publication
(10) Pub. No.: US 2021/0340309 A1
(43) Pub. Date: Nov. 4, 2021

(54) Polymeric Material Including a Uretdione-Containing Material and an Epoxy Component, Two-Part Compositions, and Methods

(71) Applicant: 3M INNOVATIVE PROPERTIES COMPANY, St. Paul, MN (US)

(72) Inventors: Kolby L. White, Woodbury, MN (US); Joseph D. Rule, Woodbury, MN (US); Matthew J. Kryger, Hudson, WI (US); Michael A. Kropp, Cottage Grove, MN (US); Jay S. Schlechte, Oakdale, MN (US); Zachary J. Thompson, Woodbury, MN (US)

(21) Appl. No.: 17/284,814

(22) PCT Filed: Dec. 4, 2019
(86) PCT No.: PCT/IB2019/060434

§ 371 Date: Apr. 13, 2021

Related U.S. Application Data
(60) Provisional application No. 62/779,038, filed on Dec. 13, 2018.

(51) Int. Cl. C08G 18/79; C08G 18/80; C08G 18/58; C08G 18/32; C08G 18/50; C08G 18/48; C09D 175/12; C09J 175/12

(52) U.S. Cl. CPC C08G 18/798; C08G 18/80; C08G 18/58; C09J 175/12; C08G 18/5024; C08G 18/4833; C09D 175/12; C08G 18/3206

(57) ABSTRACT

The present disclosure provides a polymeric material including a polymerized reaction product of a polymerizable composition including components and has a solids content of 90% or greater. The components include a uretdione-containing material including a reaction product of a diisocyanate reacted with itself; a first hydroxyl-containing compound; an optional second hydroxyl-containing compound having a single OH group, wherein; and an epoxy component. The epoxy component is present in an amount of 35% by weight or greater, based on the total weight of the polymerizable composition. The first hydroxyl-containing compound has more than one OH group and the optional second hydroxyl-containing compound is a primary alcohol or a secondary alcohol. The present disclosure also provides a two-part composition, in which the polymeric material is included in the first part and the second includes at least one amine. Further, a method of adhering two substrates is provided, including obtaining a two-part composition; combining at least a portion of the first part with at least a portion of the second part to form a mixture; disposing at least a portion of the mixture on a first substrate; and contacting a second substrate with the mixture disposed on the first substrate. The disclosure also provides a polymeric material and a method of making a two-part composition. Advantageously, two-part compositions can be used as coatings and adhesive systems with handling and performance similar to existing two-part urethane systems, but with less sensitivity to water, or with performance similar to toughened epoxy systems.

### TECHNICAL FIELD

The present disclosure relates to polymeric materials that include uretdione-containing materials and epoxy components, such as two-part compositions.

### BACKGROUND

Two-part urethane adhesives and sealants are commercially available from a variety of companies. These systems typically involve one component that is an oligomer/polymer terminated with isocyanate groups and a second component that is a polyol. When mixed, the isocyanate reacts with polyol to form carbamate groups. While this is established and effective chemistry, it suffers from a sensitivity to moisture due to ability of the isocyanate to be deactivated when reacted with water. Hence, there remains a need for adhesives and sealants that advantageously have less sensitivity to water.

### SUMMARY

In a first aspect, a polymeric material is provided. The polymeric material includes a polymerized reaction product of a polymerizable composition comprising components and has a solids content of 90% or greater. The components include (a) a uretdione-containing material comprising a reaction product of a diisocyanate reacted with itself; (b) a first hydroxyl-containing compound having more than one OH group; (c) an optional second hydroxyl-containing compound having a single OH group, wherein the second hydroxyl-containing compound is a primary alcohol or a secondary alcohol; and (d) an epoxy component. The epoxy component is present in an amount of 35% by weight or greater, based on the total weight of the polymerizable composition.

In a second aspect, a two-part composition is provided. The two-part composition includes (a) a first part comprising a polymeric material; and (b) a second part including at least one amine. At least one molecule of the at least one amine has an average amine functionality of 2.0 or greater, wherein each amine is a primary amine or a secondary amine. The polymeric material includes a polymerized reaction product of a polymerizable composition including components and has a solids content of 90% or greater. The components include (i) a uretdione-containing material comprising a reaction product of a diisocyanate reacted with itself; (ii) a first hydroxyl-containing compound having more than one OH group; (iii) an optional second hydroxyl-containing compound having a single OH group, wherein the second hydroxyl-containing compound is a primary alcohol or a secondary alcohol; and (iv) an epoxy component. The epoxy component is present in an amount of 35% by weight or greater, based on the total weight of the polymerizable composition.

In a third aspect, a polymerized product is provided. The polymerized product is polymerized product of a two-part composition. The two-part composition includes (a) a first part comprising a polymeric material; and (b) a second part including at least one amine. At least one molecule of the at least one amine has an average amine functionality of 2.0 or greater, and each amine is a primary amine or a secondary amine. The polymeric material includes a polymerized reaction product of a polymerizable composition including components and has a solids content of 90% or greater. The components include (i) a uretdione-containing material comprising a reaction product of a diisocyanate reacted with itself; (ii) a first hydroxyl-containing compound having more than one OH group; (iii) an optional second hydroxyl-containing compound having a single OH group, wherein the second hydroxyl-containing compound is a primary alcohol or a secondary alcohol; and (iv) an epoxy component. The epoxy component is present in an amount of 35% by weight or greater, based on the total weight of the polymerizable composition.

In a fourth aspect, a method of adhering two substrates together is provided. The method includes (a) obtaining a two-part composition; (b) combining at least a portion of the first part with at least a portion of the second part to form a mixture; (c) disposing at least a portion of the mixture on a first major surface of a first substrate; and (d) contacting a first major surface of a second substrate with the mixture disposed on the first substrate. The first part includes a polymeric material including a polymerized reaction product of a polymerizable composition including components. The components include (i) a uretdione-containing material comprising a reaction product of a diisocyanate reacted with itself; (ii) a first hydroxyl-containing compound having more than one OH group; (iii) an optional second hydroxyl-containing compound having a single OH group, wherein the second hydroxyl-containing compound is a primary alcohol or a secondary alcohol; and (iv) an epoxy component. The epoxy component is present in an amount of 35% by weight or greater, based on the total weight of the polymerizable composition. The polymeric material has a solids content of 90% or greater. The second part includes at least one amine, wherein at least one molecule of the at least one amine has an average amine functionality of 2.0 or greater and each amine is a primary amine or a secondary amine.

In a fifth aspect, a method of making a two-part composition is provided. The method includes (a) providing a first part by forming a polymeric material; and (b) providing a second part including at least one amine. The polymeric material includes a polymerized reaction product of a polymerizable composition including components. The components include (i) a uretdione-containing material comprising a reaction product of a diisocyanate reacted with itself; (ii) a first hydroxyl-containing compound having more than one OH group; (iii) an optional second hydroxyl-containing compound having a single OH group, wherein the second hydroxyl-containing compound is a primary alcohol or a secondary alcohol; and (iv) an epoxy component. The epoxy component is present in an amount of 35% by weight or greater, based on the total weight of the polymerizable composition. The polymeric material has a solids content of 90% or greater. At least one molecule of the at least one amine has an average amine functionality of 2.0 or greater, and each amine is a primary amine or a secondary amine.

The inclusion of the epoxy component imparts a desirable decrease in the viscosity of the polymeric material including uretdione-containing material, as well as imparting at least certain desirable properties to polymerized products from compositions containing high amounts of the epoxy component. The above summary is not intended to describe each embodiment or every implementation of aspects of the invention. The details of various embodiments are set forth in the description below. Other features, objects, and advantages will be apparent from the description and from the claims.

### BRIEF DESCRIPTION OF DRAWINGS

FIG. 1 is a flow chart of an exemplary method of adhering two substrates together, according to the present disclosure.

FIG. 2 is a schematic cross-sectional view of an exemplary article including two substrates adhered together, preparable according to the present disclosure.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

The present disclosure provides polymeric materials, polymerizable compositions, and two-part compositions useful for instance in coatings and/or adhesives that have good flowability and reactivity (e.g., without added solvent), acceptable cure and/or adhesion in a short amount of time, as compared to similar compositions instead containing isocyanates. Further, coatings and adhesives according to at least certain embodiments of the present disclosure are essentially free of isocyanates. This is advantageous because isocyanates tend to be sensitizers upon first contact (e.g., to skin) such that subsequent contact causes inflammation. Coatings/adhesives containing isocyanates exhibit more sensitivity to water than other compounds, as noted above, so minimizing an isocyanate content in a coating or adhesive may improve reliability during curing as well as simplify storage and handling of the polymeric materials, polymerizable compositions, and two-part compositions.

The terms “a”, “an”, “the”, “at least one”, and “one or more” are used interchangeably.

The term “and/or” means one or both such as in the expression A and/or B refers to A alone, B alone, or to both A and B.

The term “essentially” means 95% or more.

The term “equivalents” refers to the number of moles of a functional group (e.g., OH groups, isocyanate groups, uretdione groups, etc.) per molecule of a polymer chain or per mole of a different functional group.

The term “alkyl” refers to a monovalent radical of an alkane. Suitable alkyl groups can have up to 50 carbon atoms, up to 40 carbon atoms, up to 30 carbon atoms, up to 20 carbon atoms, up to 16 carbon atoms, up to 12 carbon atoms, up to carbon atoms, up to 8 carbon atoms, up to 6 carbon atoms, up to 4 carbon atoms, or up to 3 carbon atoms. The alkyl groups can be linear, branched, cyclic, or a combination thereof. Linear alkyl groups often have 1 to 30 carbon atoms, 1 to 20 carbon atoms, 1 to 10 carbon atoms, 1 to 6 carbon atoms, or 1 to 4 carbon atoms. Branched alkyl groups often have 3 to 50 carbon atoms, 3 to 40 carbon atoms, 4 to 20 carbon atoms, 3 to 10 carbon atoms, or 3 to 6 carbon atoms. Cyclic alkyl groups often have 3 to 50 carbon atoms, 5 to 40 carbon atoms, 6 to 20 carbon atoms, 5 to 10 carbon atoms, or 6 to 10 carbon atoms.

The term “alkylene” refers to a divalent group that is a radical of an alkane. The alkylene can be straight-chained, branched, cyclic, or combinations thereof. The alkylene typically has 1 to 20 carbon atoms. In some embodiments, the alkylene contains 4 to 14 carbon atoms, 1 to 10 carbon atoms, 1 to 8 carbon atoms, 1 to 6 carbon atoms, or 1 to 4 carbon atoms. The radical centers of the alkylene can be on the same carbon atom (i.e., an alkylidene) or on different carbon atoms. In certain embodiments, the alkylene can be substituted with an OH group.

The term “alkane-triyl” refers to a trivalent radical of an alkane.

The term “aryl” refers to a monovalent group that is radical of an arene, which is a carbocyclic, aromatic compound. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, naphthyl, acenaphthyl, anthraquinonyl, phenanthryl, anthracenyl, pyrenyl, perylenyl, and fluorenyl.

The term “aralkyl” refers to a monovalent group of formula —R—Ar where R is an alkylene and Ar is an aryl group. That is, the aralkyl is an alkyl substituted with an aryl.

The term “aralkylene” refers to a divalent group of formula —R—Ar^{a}— where R is an alkylene and Ar^{a} is an arylene (i.e., an alkylene is bonded to an arylene).

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene. The term “alkarylene” refers to a divalent group that is an arylene group substituted with an alkyl group or an arylene group attached to an alkylene group. Unless otherwise indicated, the alkarylene group typically has from 1 to 20 carbon atoms, 4 to 14 carbon atoms, 1 to 10 carbon atoms, 1 to 6 carbon atoms, or 1 to 4 carbon atoms. Unless otherwise indicated, for both groups, the alkyl or alkylene portion typically has from 1 to 20 carbon atoms, 1 to 10 carbon atoms, 1 to 6 carbon atoms, or 1 to 4 carbon atoms. Unless otherwise indicated, for both groups, the aryl or arylene portion typically has from 6 to 20 carbon atoms, 6 to 18 carbon atoms, 6 to 16 carbon atoms, 6 to 12 carbon atoms, or 6 to 10 carbon atoms. In certain embodiments, the arylene group or the alkarylene group has 4 to 14 carbon atoms.

The term “aprotic” refers to a component that does not have a hydrogen atom bound to an oxygen (as in a hydroxyl group) or a nitrogen (as in an amine group). In general terms, any component that does not contain labile H+ is called an aprotic component. The molecules of such components cannot donate protons (H+) to other components.

The term “carbamate” refers to a compound having the general formula R—N(H)—C(O)—O—R′. Preferred R groups include alkylene groups.

The term “diisocyanate” refers to a compound having the general formula O═C═N—R—N═C═O. Preferred R groups include alkylene and arylene groups.

The term “diol” refers to a compound with two OH groups.

The term “triamine” refers to a compound with three amino groups.

The term “polyester” refers to repeating difunctional polymer wherein the repeat units are joined by ester linkages. Ester groups have the general formula —R—C(O)—OR′. The term “polyether” refers to repeating difunctional alkoxy radicals having the general formula —O—R—. Preferred R and R′ groups have the general formula —CₙH₂ₙ— and include, for example, methylene, ethylene and propylene (including n-propylene and i-propylene) or a combination thereof. Combinations of R and R′ groups may be provided, for example, as random or block type copolymers.

The term “polyol” refers to a compound with two or more hydroxyl (i.e., OH) groups.

The term “polymeric material” refers to any homopolymer, copolymer, terpolymer, and the like, as well as any diluent.

The term “non-reactive diluent” refers to a component that can be added to adjust the viscosity of the polymerizable composition. By “non-reactive” it is meant that the diluent does not participate in a polymerization reaction (e.g., with an amine, a uretdione-containing material, or a hydroxyl-containing compound having one or more OH groups), of the polymerizable composition. The diluent does not react with such components during manufacture of a two-part composition, during manufacture of a coating or adhesive, during application of the coating or adhesive to a substrate, or upon aging. Typically, the diluent is substantially free of reactive groups. In some embodiments, the molecular weight of the unreactive diluent is less than the molecular weight of components such as the uretdione-containing material. The non-reactive diluent is not volatile, and substantially remains in the coating or adhesive after curing. The boiling point of the non-reactive diluent may be greater than 200° C.

The term “reactive diluent” refers to a component that can be added to adjust the viscosity of the polymerizable composition and does participate in a polymerization reaction (e.g., with an amine, a uretdione-containing material, or a hydroxyl-containing compound having one or more OH groups), of the polymerizable composition. The diluent reacts with such components during at least one of: during application of the coating or adhesive to a substrate or upon aging. The diluent includes one or more reactive groups, such as epoxy groups. In some embodiments, the molecular weight of the reactive diluent is less than the molecular weight of components such as the uretdione-containing material.

The term “primary alcohol” refers to an alcohol in which the OH group is connected to a primary carbon atom (e.g., having the general formula —CH₂OH). The term “secondary alcohol” refers to an alcohol in which the OH group is connected to a secondary carbon atom (e.g., having the general formula —CHROH, where R is a group containing a carbon atom).

The term “ambient temperature” refers to a temperature in the range of 20 degrees Celsius to 25 degrees Celsius, inclusive.

In a first aspect, a polymeric material is provided. The polymeric material includes a polymerized reaction product of a polymerizable composition including components and has a solids content of 90% or greater. The components include a uretdione-containing material including a reaction product of a diisocyanate reacted with itself; a first hydroxyl-containing compound having more than one OH group; an optional second hydroxyl-containing compound having a single OH group; and an epoxy component. The epoxy component is present in an amount of 35% by weight or greater, based on the total weight of the polymerizable composition. The optional second hydroxyl-containing compound is a primary alcohol or a secondary alcohol. Stated another way, the first aspect provides:

A polymeric material comprising a polymerized reaction product of a polymerizable composition comprising components, the components comprising:
(a) a uretdione-containing material comprising a reaction product of a diisocyanate reacted with itself;
(b) a first hydroxyl-containing compound having more than one OH group;
(c) an optional second hydroxyl-containing compound having a single OH group, wherein the second hydroxyl-containing compound is a primary alcohol or a secondary alcohol; and
(d) an epoxy component in an amount of 35% by weight or greater, based on the total weight of the polymerizable composition;
   wherein the polymeric material comprises a solids content of 90% or greater.

A uretdione can be formed by the reaction of a diisocyanate with itself and has the following general formula:

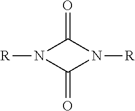

In some embodiments, the diisocyanate comprises a functional group selected from Formula X, Formula XI, and Formula XII:

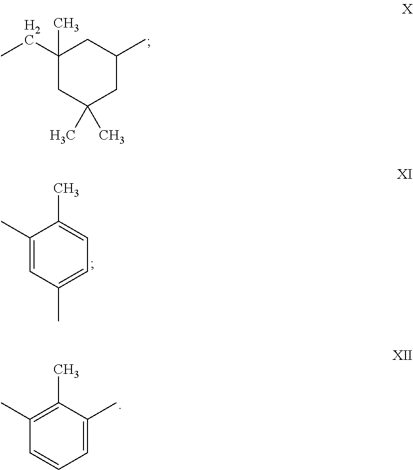

There are a variety of reaction products that can occur as a diisocyanate reacts with itself, and typically the reaction of a diisocyanate with itself results in a blend of two or more reaction products. Preferably, the reaction of a diisocyanate with itself proceeds to a degree such that the polymeric material contains 25% by weight or less or 23% by weight or less of isocyanate groups, as determined by infrared Fourier Transform spectroscopy (e.g., a Nicolet 6700 FT-IP Spectrometer, Thermo Scientific (Madison, Wis.)) where the weight percent of isocyanate in a material is calculated as the moles of isocyanate functional groups multiplied by 42 grams per mole (g/mol) and divided by the mass of the material.

In certain embodiments, the uretdione-containing material comprises a compound of Formula I:

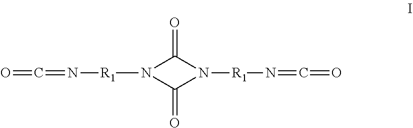

wherein R₁ is independently selected from a C₄ to C₁₄ alkylene, arylene, and alkaralyene. In some embodiments, the diisocyanate comprises hexamethylene diisocyanate. One preferable uretdione-containing material is a hexamethylene diisocyanate-based blend of materials comprising uretdione functional groups, commercially available under the trade name DESMODUR N3400 from Covestro (Leverkusen, Germany). Additional uretdione-containing materials are commercially available under the trade name CRELAN EF 403 also from Covestro, and under the trade name METALINK U/ISOQURE TT from Isochem Incorporated (New Albany, Ohio).

Typically, the polymerized reaction product (of the polymeric material) comprises greater than one uretdione functional group in a backbone of the polymerized reaction product, such as an average of 1.1 or greater of a uretdione functional group in a backbone of the polymerized reaction product, 1.2 or greater, 1.3 or greater, 1.4 or greater, 1.5 or greater, 1.6 or greater, 1.8 or greater, 2.0 or greater, 2.2 or greater, 2.4 or greater, 2.6 or greater, 2.8 or greater, 3.0 or greater, 3.2 or greater, 3.4 or greater, or 3.6 or greater; and an average of 6.0 or less of a uretdione functional group in a backbone of the polymerized reaction product, 5.8 or less, 5.6 or less, 5.4 or less, 5.2 or less, 5.0 or less, 4.8 or less, 4.6 or less, 4.4 or less, 4.2 or less, 4.0 or less, 3.8 or less, 3.5 or less, 3.3 or less, 3.1 or less, 2.9 or less, 2.7 or less, 2.5 or less, 2.3 or less, 2.1 or less, or even an average of 1.9 or less of a uretdione functional group in a backbone of the polymerized reaction product. Stated another way, the polymerized reaction product may comprise an average of 1.3 to 6.0, inclusive, or 1.5 to 4.0, inclusive, of a uretdione functional group in a backbone of the polymerized reaction product. In select embodiments, the polymerized reaction product comprises an average of 1.3 to 5.0, inclusive, of a uretdione functional group in a backbone of the polymerized reaction product and the polymerizable composition is free of the second hydroxyl-containing compound. The amount of the uretdione functional group can be determined as described in the Examples below.

One exemplary simplified general reaction scheme of a uretdione-containing material with a first-hydroxyl-containing compound and an (optional) second hydroxyl-containing compound is provided below in Scheme 1:

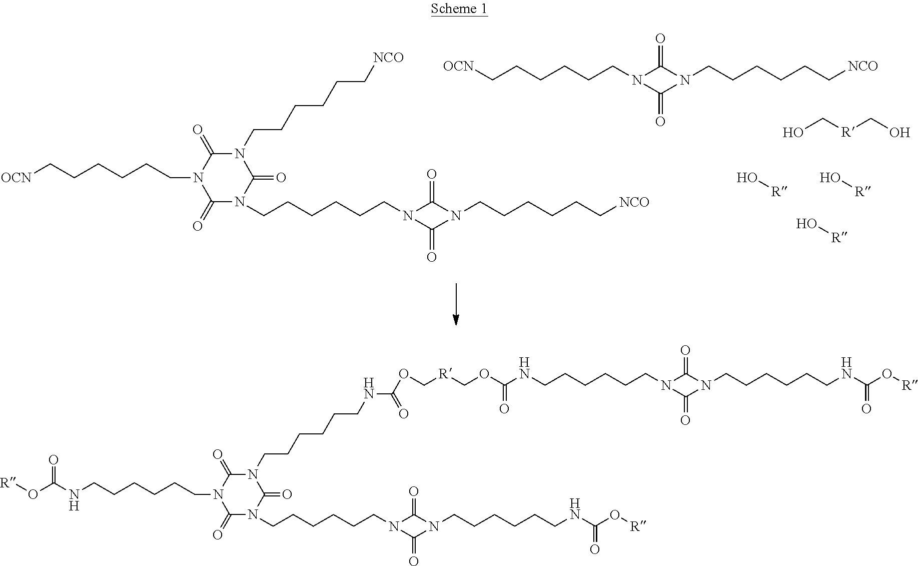

In the particular reaction scheme of Scheme 1, the uretdione-containing material comprises two compounds containing uretdione groups, one of which also contains an isocyanurate compound. In certain embodiments of the polymeric material, the polymerized reaction product (of the polymeric material) comprises an average of 1.3 or fewer isocyanurate units per molecule of the polymerized reaction product. This can be because isocyanurate units may not contribute desirable properties to the polymeric material.

Similarly, an exemplary simplified general reaction scheme of a uretdione-containing material with a first-hydroxyl-containing compound, but without the optional second hydroxyl-containing compound is provided below in Scheme 2:

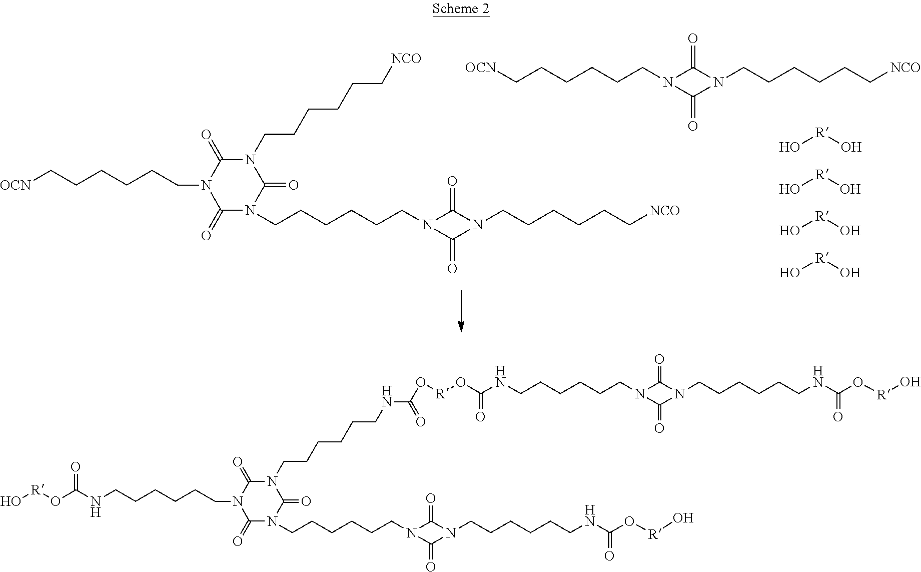

The polymerized reaction product (of the polymeric material) also typically comprises one or more carbamate functional groups per molecule of the polymerized reaction product in a backbone of the polymerized reaction product. The carbamate functional groups are formed by the reaction of the first hydroxyl-containing compound (and optionally the second hydroxyl-containing compound) with the isocyanate groups present on uretdione-containing compounds. For example, the polymerized reaction product may comprise an average of 0.2 or greater of carbamate functional groups in the backbone of the polymerized reaction product, 0.5 or greater, 1 or greater, 2 or greater, 3 or greater, 4 or greater, 5 or greater, 6 or greater, 7 or greater, or an average of 8 or greater of carbamate functional groups in the backbone of the polymerized reaction product; and an average of 18 or less of carbamate functional groups in the backbone of the polymerized reaction product, 17 or less, 16 or less, 15 or less, 14 or less, 13 or less, 12 or less, 11 or less, 10 or less, or an average of 9 or less of carbamate functional groups in the backbone of the polymerized reaction product. Stated another way, the polymerized reaction product may comprise an average of 0.2 to 18, inclusive, or 2 to 10, inclusive, of carbamate functional groups in the backbone of the polymerized reaction product. The average carbamate functional group content of the polymerized reaction product can be determined as described in the Examples below.

In certain embodiments, the first hydroxyl-containing compound is an alkylene polyol, a polyester polyol, or a polyether polyol. Often the first hydroxyl-containing compound is a diol, such as a branched diol. For example, in some embodiments the first hydroxyl-containing compound is of Formula II:

HO—R₂—OH II

wherein R₂ is selected from R₃, an alkylene, and an alkylene substituted with an OH group, wherein R₃ is of Formula III or Formula IV:

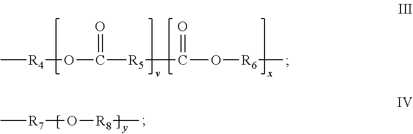

wherein each of R₄, R₅, R₆, R₇, and R₈ is independently an alkylene, wherein each of v and y is independently 1 to 40, and wherein x is selected from 0 to 40. Optionally, R₂ is selected from C₁ to C₂₀ alkylene and a C₁ to C₂₀ alkylene substituted with an OH group.

In certain embodiments of the first hydroxyl-containing compound, each of R₄, R₅, R₆, R₇, and R₈ is independently selected from a C₁ to C₂₀ alkylene. Alternatively, the first hydroxyl-containing compound can be of Formula V or Formula VI:

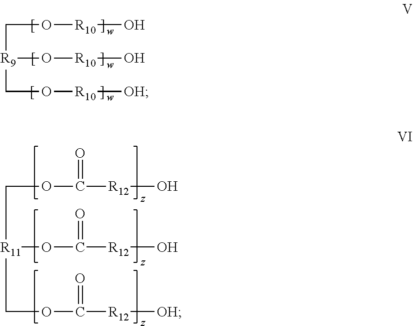

wherein each of R₉ and R₁₁ is independently an alkane-triyl, wherein each of R₁₀ and R₁₂ is independently selected from an alkylene, and wherein each of w and z is independently selected from 1 to 20. Preferably, each of R₁₀ and R₁₂ is independently selected from a C₁ to C₂₀ alkylene.

Suitable first hydroxyl-containing compounds include branched alcohols, secondary alcohols, or ethers, for instance and without limitation, 2,2-dimethyl-1,3-propanediol, 2-methyl-1,3-propanediol, diethylene glycol, poly(tetramethylene ether) glycol, 2-ethylhexane-1,3-diol, and 1,3-butanediol. Such suitable first hydroxyl-containing compounds are commercially available from chemical suppliers including for example, Alfa Aesar (Ward Hill, Mass.), JT Baker (Center Valley, Pa.), TCI (Portland, Oreg.), and Fisher Scientific (Waltham, Mass.).

In certain embodiments, the optional second hydroxyl-containing compound is an alkyl alcohol, a polyester alcohol, or a polyether alcohol, such as a branched alcohol and/or a secondary alcohol. For example, in some embodiments the second hydroxyl-containing compound is present and is of Formula VII:

R₁₃—OH VII;

wherein R₁₃ is selected from R₁₄, R₁₅, and a C₁ to C₅₀ alkyl;

wherein R₁₄ is of Formula VIII:

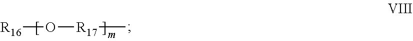

wherein m=1 to 20, R₁₆ is an alkyl, and R₁₇ is an alkylene;

wherein R₁₅ is of Formula IX:

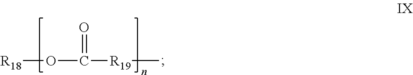

wherein n=1 to 20, R₁₈ is an alkyl, and R₁₉ is an alkylene. Preferably, R₁₃ is a C₄-C₂₀ alkyl, as the alkyl groups below C₄ have a tendency to form a crystalline polymeric material.

Suitable optional second hydroxyl-containing compounds can include branched alcohols or secondary alcohols, for instance and without limitation, 2-butanol, 2-ethyl-1-hexanol, isobutanol, and 2-butyl-octanol, each of which is commercially available from Alfa Aesar (Ward Hill, Mass.).

In an embodiment, first hydroxyl-containing compound is of Formula II and the optional second hydroxyl-containing compound is present and of Formula VII, wherein R₂ of the compound of Formula II is of Formula III, and wherein R₁₃ of the compound of Formula VII is a branched C₄ to C₂₀ alkyl.

In select embodiments, the first hydroxyl-containing compound is a diol and the reaction product comprises 0.2 to 0.65, inclusive, or 0.25 to 0.61, inclusive, of diol equivalents relative to isocyanate equivalents. Optionally, a sum of the OH equivalents of the first hydroxyl-containing compound and the (optional) second hydroxyl-containing compound is equal to or greater than the isocyanate equivalents of the polymeric material.

Preferably, the polymeric material is essentially free of isocyanates. By “essentially free of isocyanates” it is meant that the polymeric material contains 5% by weight or less, 4% by weight or less, 3% by weight or less, 2% by weight or less, or 1% by weight or less of isocyanate groups, as determined by infrared Fourier Transform spectroscopy (e.g., a Nicolet 6700 FT-IP Spectrometer, Thermo Scientific (Madison, Wis.)), where the weight percent of isocyanate in a material is calculated as the moles of isocyanate functional groups multiplied by 42 g/mol and divided by the mass of the material.

The components include at least one epoxy component. It has been discovered that the introduction of a reactive epoxy diluent results in an improvement in the viscosity of a polymeric material including a uretdione-containing material, such that use of crystalline or high viscosity uretdione-containing materials has been enabled. Moreover, it has been discovered that the use of a large amount of epoxy component (e.g., 35 wt. % or more) with a uretdione-containing material can result in a coating or adhesive that exhibits toughening as compared to an epoxy material without the uretdione-containing material.

Further, using a high amount of epoxy component(s) in a composition, greater strength of the resulting polymerized product is achieved than using a uretdione-containing material containing a small amount of epoxy component(s). The polymerized product will also tend to have a higher modulus than the same composition lacking any epoxy component.

The epoxy component may optionally include an epoxy resin comprising one or more epoxy compounds that can be monomeric or polymeric, and aliphatic, cycloaliphatic, heterocyclic, aromatic, hydrogenated, and/or a mixture thereof. Preferred epoxy compounds contain more than 1.5 epoxy groups per molecule and more preferably at least 2 epoxide groups per molecule.

The epoxy component can include linear polymeric epoxides having terminal epoxy groups (e.g., a diglycidyl ether of a polyoxyalkylene glycol), polymeric epoxides having skeletal epoxy groups (e.g., polybutadiene poly epoxy), polymeric epoxides having pendant epoxy groups (e.g., a glycidyl methacrylate polymer or copolymer), or a mixture thereof.

Exemplary epoxy compounds include, for example, aliphatic (including cycloaliphatic) and aromatic epoxy compounds. The epoxy compound(s) may be monomeric, oligomeric, or polymeric epoxides, or a combination thereof. The epoxy component may be a pure compound or a mixture comprising at least two epoxy compounds. The epoxy component typically has, on average, at least 1 epoxy (i.e., oxiranyl) group per molecule, preferably at least about 1.5 and more preferably at least about 2 epoxy groups per molecule. Hence, the epoxy component may comprise at least one monofunctional epoxy, and/or may comprise at least one multifunctional epoxy. In some cases, 3 (e.g., trifunctional), 4, 5, or even 6 epoxy groups may be present, on average.

Polymeric epoxides include linear polymers having terminal epoxy groups (e.g., a diglycidyl ether of a polyoxyalkylene glycol), polymers having skeletal oxirane units (e.g., polybutadiene polyepoxide), and polymers having pendent epoxy groups (e.g., a glycidyl methacrylate polymer or copolymer). Other useful epoxy components are polyhydric phenolic formaldehyde condensation products as well as polyglycidyl ethers that contain as reactive groups only epoxy groups or hydroxy groups. In certain embodiments, the epoxy component comprises at least one glycidyl ether group. The “average” number of epoxy groups per molecule can be determined by dividing the total number of epoxy groups in the epoxy-containing material by the total number of epoxy-containing molecules present.

The choice of epoxy component may depend upon the intended end use. For example, epoxides with flexible backbones may be desired where a greater amount of ductility is needed in the bond line. Materials such as diglycidyl ethers of bisphenol A and diglycidyl ethers of bisphenol F can help impart desirable structural adhesive properties upon curing, while hydrogenated versions of these epoxies may be useful for compatibility with substrates having oily surfaces.

Commercially available epoxy compounds include octadecylene oxide, epichlorohydrin, styrene oxide, vinylcyclohexene oxide, glycidol, glycidyl methacrylate, vinylcyclohexene dioxide, 3,4-epoxycyclohexylmethyl-3,4-epoxycyclohexenecarboxylate, 3,4-epoxy-6-methylcyclohexylmethyl-3,4-epoxy-6-methylcyclohexene carboxylate, bis(3,4-epoxy-6-methylcyclohexylmethyl) adipate, bis(2,3-epoxycyclopentyl) ether, dipentene dioxide, silicone resin containing epoxy functionality, flame retardant epoxy resins (e.g., DER-580, a brominated bisphenol type epoxy resin available from Dow Chemical Co.), 1,4-butanediol diglycidyl ether of phenol-formaldehyde novolac (e.g., DEN-431 and DEN-438 from Dow Chemical Co.), and resorcinol diglycidyl ether (e.g., Kopoxite from Koppers Company, Inc.), bis(3,4-epoxycyclohexyl)adipate, 2-(3,4-epoxycyclohexyl-5,5-spiro-3,4-epoxy) cyclohexene metadioxane, vinylcyclohexene monoxide 1,2-epoxyhexadecane, alkyl glycidyl ethers such as (e.g., HELOXY Modifier 7 from Momentive Specialty Chemicals, Inc., Waterford, N.Y.), alkyl C12-C14 glycidyl ether (e.g., HELOXY Modifier 8 from Momentive Specialty Chemicals, Inc.), butyl glycidyl ether (e.g., HELOXY Modifier 61 from Momentive Specialty Chemicals, Inc.), cresyl glycidyl ether (e.g., HELOXY Modifier 62 from Momentive Specialty Chemicals, Inc.), p-tert-butylphenyl glycidyl ether (e.g., HELOXY Modifier 65 from Momentive Specialty Chemicals, Inc.), polyfunctional glycidyl ethers such as diglycidyl ether of 1,4-butanediol (e.g., HELOXY Modifier 67 from Momentive Specialty Chemicals, Inc.), diglycidyl ether of neopentyl glycol (e.g., HELOXY Modifier 68 from Momentive Specialty Chemicals, Inc.), diglycidyl ether of cyclohexanedimethanol (e.g., HELOXY Modifier 107 from Shell Chemical Co.), trimethylolethane triglycidyl ether (e.g., HELOXY Modifier 44 from Momentive Specialty Chemicals, Inc.), trimethylolpropane triglycidyl ether (e.g., HELOXY Modifier 48 from Momentive Specialty Chemicals, Inc.), polyglycidyl ether of an aliphatic polyol (e.g., HELOXY Modifier 84 from Momentive Specialty Chemicals, Inc.), polyglycol diepoxide (e.g., HELOXY Modifier 32 from Momentive Specialty Chemicals, Inc.), bisphenol F epoxides, 9,9-bis[4-(2,3-epoxypropoxy)phenyl]fluorenone (e.g., EPON 1079 from Momentive Specialty Chemicals, Inc.).

In certain embodiments, the epoxy component comprises an epoxidised (poly)olefinic resin, an epoxidised phenolic novolac resin, an epoxidised cresol novolac resin, a cycloaliphatic epoxy resin, or a combination thereof. Commercially available epoxy resins include for instance, epoxidised linseed oil (e.g., VIKOFLEX 7190 from Arkema Inc., King of Prussia, Pa.), epoxy phenol novolac resin (e.g., EPALLOY 8250 from CVC Specialty Chemicals, Moorestown, N.J.), multifunctional ephichlorohydrin/cresol novolac epoxy resin (e.g., EPON 164 from Hexion Specialty Chemicals GmbH, Rosbach, Germany), and cycloaliphatic epoxy resin (e.g., CELLOXIDE 2021 from Daicel Chemical Industries, Ltd., Tokyo, Japan).

In some embodiments, the epoxy component contains one or more epoxy compounds having an epoxy equivalent weight of from 100 g/mole to 1500 g/mol. More preferably, the epoxy resin contains one or more epoxy compounds having an epoxy equivalent weight of from 300 g/mole to 1200 g/mole. Even more preferably, the curable composition contains two or more epoxy compounds, wherein at least one epoxy resin has an epoxy equivalent weight of from 300 g/mole to 500 g/mole, and at least one epoxy resin has an epoxy equivalent weight of from 1000 g/mole to 1200 g/mole.

Useful epoxy compounds also include glycidyl ethers, e.g., such as those prepared by reacting a polyhydric alcohol with epichlorohydrin. Such polyhydric alcohols may include butanediol, polyethylene glycol, and glycerin.

Useful epoxy compounds also include aromatic glycidyl ethers, e.g., such as those prepared by reacting a polyhydric phenol with an excess of epichlorohydrin, cycloaliphatic glycidyl ethers, hydrogenated glycidyl ethers, and mixtures thereof. Such polyhydric phenols may include resorcinol, catechol, hydroquinone, and the polynuclear phenols such as p,p′-dihydroxydibenzyl, p,p′-dihydroxydiphenyl, p,p′-dihydroxyphenyl sulfone, p,p′-dihydroxybenzophenone, 2,2′-dihydroxy-1,1-dinaphthylmethane, and the 2,2′-, 2,3′-, 2,4′-, 3,3′-, 3,4′-, and 4,4′-isomers of dihydroxydiphenylmethane, dihydroxydiphenyldimethylmethane, dihydroxydiphenylethylmethylmethane, dihydroxydiphenylmethylpropylme thane, dihydroxy-diphenylethylphenylmethane, dihydroxydiphenylpropylphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Similarly, useful epoxy compounds also include a polyglycidyl ether of a polyhydric phenol. Example polyglycidyl ethers of a polyhydric phenol include a polyglycidyl ether of bisphenol A, bisphenol F, bisphenol AD, catechol, or resorcinol.

Useful epoxy compounds also include glycidyl ether esters and polyglycidyl esters. A glycidyl ether ester may be obtained by reacting a hydroxycarboxylic acid with epichlorohydrin. A polyglycidyl ether may be obtained by reacting a polycarboxylic acid with epichlorohydrin. Such polycarboxylic acids may include a dimer acid (e.g., RADIACID 0950 from Oleon, Simpsonville, S.C.), and a trimer acid (e.g., RADIACID 0983 from Oleon). Suitable glycidyl esters include a glycidyl ester of neodecanoic acid (e.g., ERISYS GS-110 from CVC Specialty Chemicals) and a glycidyl ester of a dimer acid (e.g., DRISYS GS-120 from CVC Specialty Chemicals).

Exemplary epoxy compounds also include glycidyl ethers of bisphenol A, bisphenol F, and novolac resins as well as glycidyl ethers of aliphatic or cycloaliphatic diols. Examples of commercially available glycidyl ethers include diglycidyl ethers of bisphenol A such as those available as EPON 828, EPON 1001, EPON 1310, and EPON 1510 from Hexion Specialty Chemicals GmbH, Rosbach, Germany; those available under the trade name D.E.R. (e.g., D.E.R. 331, 332, and 334) from Dow Chemical Co., Midland, Mich.; those available under the trade name EPICLON from Dainippon Ink and Chemicals, Inc. (e.g., EPICLON 840 and 850) and those available under the trade name YL-980 from Japan Epoxy Resins Co., Ltd.); diglycidyl ethers of bisphenol F (e.g., those available under the trade name EPICLON from Dainippon Ink and Chemicals, Inc. (e.g., EPICLON 830)); glycidyl ethers of novolac resins (e.g., novolac epoxy resins, such as those available under the trade name D.E.N. from Dow Chemical Co. (e.g., D.E.N. 425, 431, and 438)); and flame retardant epoxy resins (e.g., D.E.R. 580, a brominated bisphenol type epoxy resin available from Dow Chemical Co.). In some embodiments, aromatic glycidyl ethers, such as those prepared by reacting a dihydric phenol with an excess of epichlorohydrin, may be preferred. In some embodiments, nitrile rubber modified epoxies may be used (e.g., KELPOXY 1341 available from CVC Chemical).

Certain epoxy components can advantageously be used in high amounts, e.g., 45% or more by weight, based on the total weight of a polymerizable composition, and maintain an acceptable structural integrity of a coating or adhesive. Such epoxy components preferable for use in amounts of 45 wt. % or greater, 50 wt. %, 55 wt. %, or 60 wt. % or greater, include for instance, a polyglycidyl ether of a polyhydric phenol (preferably a polyglycidyl ether of bisphenol A, bisphenol F, bisphenol AD, catechol, or resorcinol), or at least one of an epoxidised (poly)olefinic resin, epoxidised phenolic novolac resin, epoxidised cresol novolac resin, or a cycloaliphatic epoxy resin.

In some embodiments, the epoxy component has a specified Log octanol water partition coefficient (Log P). Although various methods have been described for determining the Log P of a compound, as used herein, Log P refers to the value obtained by the Moriguchi method (See Moriguchi, I; Hirono, S; Qian, L.; Nakagome, I.; and Matsushita, Y; Chemical and Pharmaceutical Bulletin, 40 (1992): 127).). The computations were conducted utilizing the software program Molecular Modeling Pro Plus from Norgwyn Montgomery Software, Inc. (North Wales, Pa.).

Log P is defined as the partitioning of the concentrations of a compound in octanol versus water:

Log P=Log([compound]_{octanol}/[compound]_{water})

Higher values of Log P are more hydrophobic, while lower values of Log P are more hydrophilic. The Moriguchi method predicts Log P via a correlation developed employing over 1200 organic molecules having a wide variety of structures. Optionally, the epoxy component exhibits a Log octanol water partition coefficient (Log P) according to the Moriguchi method of less than 27.5, less than 25, less than 23, less than 20, less than 18, less than 16, less than 14, less than 12, less than 10, less than 8, less than 6, less than 5, less than 4, less than 3, or even less than 2.3.

Low viscosity epoxy compound(s) may be included in the epoxy component, for example, to reduce viscosity as noted above. For instance, in some embodiments, the epoxy component exhibits a dynamic viscosity of 100,000 centipoises (cP) or less, 75,000 cP or less, 50,000 cP or less, 30,000 cP or less, 20,000 cP or less, 15,000 cP or less, 10,000 cP or less, 9,000 cP or less, 8,000 cP or less, 7,000 cP or less, 6,000 cP or less, 5,000 cP or less, 4,000 cP or less, or 3,000 cP or less, as determined using a Brookfield viscometer. Conditions for the dynamic viscosity test include use of a LV4 spindle at a speed of 0.3 or 0.6 revolutions per minute (RPM) at 24 degrees Celsius. In some embodiments, one or more epoxy components each has a molecular weight of 2,000 grams per mole or less. Examples of low viscosity epoxy compounds include: cyclohexanedimethanol diglycidyl ether, resorcinol diglycidyl ether, p-tert-butylphenyl glycidyl ether, cresyl glycidyl ether, diglycidyl ether of neopentyl glycol, triglycidyl ether of trimethylolethane, triglycidyl ether of trimethylolpropane, triglycidyl p-aminophenol, N,N′-diglycidylaniline, N,N,N′,N′-tetraglycidyl meta-xylylenediamine, and vegetable oil polyglycidyl ether.

The epoxy resin component is often a mixture of materials. For example, the epoxy resins can be selected to be a mixture that provides the desired viscosity or flow characteristics prior to curing. For example, within the epoxy resin may be reactive diluents that include monofunctional or certain multifunctional epoxy resins. The reactive diluent should have a viscosity which is lower than that of the epoxy resin having at least two epoxy groups. The reactive diluent tends to lower the viscosity of the epoxy/uretdione-containing material composition and often has either a branched backbone that is saturated or a cyclic backbone that is saturated or unsaturated. In select embodiments, preferred reactive diluents have only one functional group (i.e., oxirane group) such as various monoglycidyl ethers. Some exemplary monofunctional epoxy resins include, but are not limited to, those with an alkyl group having 6 to 28 carbon atoms, such as (C₆-C₂₈)alkyl glycidyl ethers, (C₆-C₂₈)fatty acid glycidyl esters, (C₆-C₂₈)alkylphenol glycidyl ethers, and combinations thereof. In the event a monofunctional epoxy resin is the reactive diluent, such monofunctional epoxy resin should be employed in an amount of up to 50 parts based on the total of the epoxy resin component.

In some embodiments, high viscosity epoxy compound(s) may be included in the epoxy component, for example, to provide structural integrity to the final composition. For instance, in some embodiments, the epoxy component exhibits a dynamic viscosity of 100,000 cP or less, 50,000 cP or less, or 20,000 cP or less; and 1,000 cP or more, as determined using a Brookfield viscometer, using the conditions described above.

The amount of epoxy included may be described relative to the amount of uretdione-containing material present. For instance, a number of equivalents of uretdione in a polymerizable composition can be 65% or less, 60% or less, 55% or less, 50% or less, 46% or less, or 45% or less, of a number of epoxy equivalents; and a number of equivalents of uretdione in the polymerizable composition can be 3% or more, 5% or more, 10% or more, 12% or more, 15% or more, 20% or more, or 25% or more, than a number of epoxy equivalents. The number of equivalents of uretdione in a polymerized reaction product can be calculated using the method described in detail in the Examples below.

In some embodiments, the polymerizable compositions typically include at 35 weight percent (wt. %) or greater epoxy component, based on the total weight of the polymerizable composition, at least 37 wt. %, at least 40 wt. %, at least 42 wt. %, at least 45 wt. %, at least 47 wt. %, at least 50 wt. %, at least 52 wt. %, at least 55 wt. %, or at least 60 wt. % epoxy resin component, based on a total weight of the curable epoxy/uretdione-containing material composition. If lower levels are used, the cured composition may not contain enough epoxy resin to provide desired coating characteristics. In some embodiments, the polymerizable composition includes up to 95 wt. %, up to 90 wt. %, up to 85 wt. %, up to 80 wt. %, up to 75 wt. %, up to 70 wt. %, or up to 65 wt. %, epoxy resin component, based on a total weight of the polymerizable composition. In select embodiments, the polymerizable compositions include the epoxy component in an amount of 35% to 95% by weight, 50% to 80% by weight, or 60% to 75% by weight, based on the total weight of the polymerizable composition.

In certain embodiments, the epoxy component is present in an amount of 35% to 95% by weight, based on the total weight of the polymerizable composition, and the epoxy component comprises a polyglycidyl ether of a polyhydric phenol and/or an epoxidised (poly)olefinic resin, an epoxidised phenolic novolac resin, an epoxidised cresol novolac resin, or a combination thereof. In some preferred embodiments, the epoxy component includes a polyglycidyl ether of bisphenol A, bisphenol F, bisphenol AD, catechol, or resorcinol. The use of such epoxy components can provide strength to a cured polymerizable composition.

In some embodiments, the epoxy component is not present at the time of the polymerization of the polymerizable composition containing the components of (a) a uretdione-containing material comprising a reaction product of a diisocyanate reacted with itself, (b) a first hydroxyl-containing compound having more than one OH group, and, if present, (c) a second hydroxyl-containing compound having a single OH group. In such embodiments, components (a), (b), and, if present, (c), are reacted, and then the epoxy component is combined with the reaction product of components (a), (b), and, if present, (c).

In alternate embodiments, the epoxy component is present at the time of reaction of components (a), (b), and, if present, (c). In such embodiments, it is preferred that most or all the epoxy component does not participate in the polymerization of the polymerizable components including components (a), (b), and, if present, (c), but rather remains available for later reaction (e.g., with a curative).

The polymeric material may further comprise one or more additives, e.g., catalysts, plasticizers, non-reactive diluents, toughening agents, fillers, flow control agents, colorants (e.g., pigments and dyes), adhesion promoters, UV stabilizers, flexibilizers, fire retardants, antistatic materials, thermally and/or electrically conductive particles, and expanding agents including, for example, chemical blowing agents such as azodicarbonamide or expandable polymeric microspheres containing a hydrocarbon liquid, such as those sold under the tradename EXPANCEL by Expancel Inc. (Duluth, Ga.).

For example, suitable catalysts can include tertiary amines, amidines, or organometallic catalysts such as tin compounds, bismuth compounds, zinc compounds, and zirconium compounds. Optionally, a bismuth carboxylate may be a suitable catalyst, for instance bismuth neodecanoate and/or bismuth ethylhexanoate. In select embodiments, the polymeric material is free of catalysts that contain tin. Either catalysts or retarders can be added to change the cure profile of the amine with the polymeric material. They can be included in either part of a two-part composition; with the polymeric material or with the amine. Suitable non-reactive diluents can include benzoate esters, for instance and without limitation ethyl benzoate, ethylhexyl benzoate, ethylhexyl hydroxystearate benzoate, C12-C15 alkyl benzoates, and dipropylene glycol dibenzoate. A commercially available non-reactive diluent includes the material available under the tradename BENZOFLEX 131 from Eastman Chemical (Kingsport, Tenn.). Additionally, organic and/or inorganic acids can be utilized as retarders to delay the cure or extend the pot-life of the material. For example, suitable acids can include carboxylic acids.

A plasticizer is often added to a polymeric material to make the polymeric material more flexible, softer, and more workable (e.g., easier to process). More specifically, the mixture resulting from the addition of the plasticizer to the polymeric material typically has a lower glass transition temperature compared to the polymeric material alone. The glass transition temperature of a polymeric material can be lowered, for example, by at least 30 degrees Celsius, at least 40 degrees Celsius, at least 50 degrees Celsius, at least 60 degrees Celsius, or at least 70 degrees Celsius by the addition of one or more plasticizers. The temperature change (i.e., decrease) tends to correlate with the amount of plasticizer added to the polymeric material. It is the lowering of the glass transition temperature that usually leads to the increased flexibility, increased elongation, and increased workability. Some example plasticizers include various phthalate esters such as diethyl phthalate, diisobutyl phthalate, dibutyl phthalate, diisoheptyl phthalate, dioctyl phthalate, diisooctyl phthalate, dinonyl phthalate, diisononyl phthalate, diisodecyl phthalate, and benzylbutyl phthalate; various adipate esters such as di-2-ethylhexyl adipate, dioctyl adipate, diisononyl adipate, and diisodecyl adipate; various phosphate esters such as tri-2-ethylhexyl phosphate, 2-ethylhexyl diphenyl phosphate, trioctylphosphate, and tricresyl phosphate; various trimellitate esters such as tris-2-ethylhexyl trimellitate and trioctyl trimellitate; various sebacate and azelate esters; and various sulfonate esters. Other example plasticizers include polyester plasticizers that can be formed by a condensation reaction of propanediols or butanediols with adipic acid. Commercially available plasticizers include those available under the tradename JAYFLEX DINA available from ExxonMobil Chemical (Houston, Tex.) and PLASTOMOLL (e.g., diisononyl adipate) from BASF (Florham Park, N.J.).

Another optional additive is a toughening agent. Toughening agents can be added to provide the desired overlap shear, peel resistance, and impact strength. Useful toughening agents are polymeric materials that may react with the epoxy resin and that may be cross-linked. Suitable toughening agents include polymeric compounds having both a rubbery phase and a thermoplastic phase or compounds which are capable of forming, with the epoxide resin, both a rubbery phase and a thermoplastic phase on curing. Polymers useful as toughening agents are preferably selected to inhibit cracking of the cured epoxy composition.

Some polymeric toughening agents that have both a rubbery phase and a thermoplastic phase are acrylic core-shell polymers wherein the core is an acrylic copolymer having a glass transition temperature below 0° C. Such core polymers may include polybutyl acrylate, polyisooctyl acrylate, polybutadiene-polystyrene in a shell comprised of an acrylic polymer having a glass transition temperature above 25° C., such as polymethylmethacrylate. Commercially available core-shell polymers include those available as a dry powder under the tradenames ACRYLOID KM 323, ACRYLOID KM 330, and PARALOID BTA 731, from Dow Chemical Co., and KANE ACE B-564 from Kaneka Corporation (Osaka, Japan). These core-shell polymers may also be available as a predispersed blend with a diglycidyl ether of bisphenol A at, for example, a ratio of 12 to 37 parts by weight of the core-shell polymer and are available under the tradenames KANE ACE (e.g., KANE ACE MX 157, KANE ACE MX 257, and KANE ACE MX 125) from Kaneka Corporation (Japan).

Another class of polymeric toughening agents that are capable of forming, with the epoxy component, a rubbery phase on curing, are carboxyl-terminated butadiene acrylonitrile compounds. Commercially available carboxyl-terminated butadiene acrylonitrile compounds include those available under the tradenames HYCAR (e.g., HYCAR 1300X8, HYCAR 1300X13, and HYCAR 1300X17) from Lubrizol Advanced Materials, Inc. (Cleveland, Ohio) and under the tradename PARALOID (e.g., PARALOID EXL-2650) from Dow Chemical (Midland, Mich.).

Other polymeric toughening agents are graft polymers, which have both a rubbery phase and a thermoplastic phase, such as those disclosed in U.S. Pat. No. 3,496,250 (Czerwinski). These graft polymers have a rubbery backbone having grafted thereto thermoplastic polymer segments. Examples of such graft polymers include, for example, (meth)acrylate-butadiene-styrene, and acrylonitrile/butadiene-styrene polymers. The rubbery backbone is preferably prepared so as to constitute from 95 wt. % to 40 wt. % of the total graft polymer, so that the polymerized thermoplastic portion constitutes from 5 wt. % to 60 wt. % of the graft polymer.

Still other polymeric toughening agents are polyether sulfones such as those commercially available from BASF (Florham Park, N.J.) under the tradename ULTRASON (e.g., ULTRASON E 2020 P SR MICRO).

Further optional additives include a flow control agent or thickener, to provide the desired rheological characteristics to the polymeric material. Suitable flow control agents include fumed silica, such as treated fumed silica, available under the tradename CAB-O-SIL TS 720, and untreated fumed silica available under the tradename CAB-O-SIL M5, from Cabot Corp. (Alpharetta, Ga.).

In some embodiments, the polymeric material optimally contains adhesion promoters other than the silane adhesion promoter to enhance the bond to the substrate. The specific type of adhesion promoter may vary depending upon the composition of the surface to which it will be adhered. Adhesion promoters that have been found to be particularly useful for surfaces coated with ionic type lubricants used to facilitate the drawing of metal stock during processing include, for example, dihydric phenolic compounds such as catechol and thiodiphenol.

The polymeric material optionally may also contain one or more fillers (e.g., aluminum powder, carbon black, glass bubbles, talc, clay, calcium carbonate, barium sulfate, titanium dioxide, silica such as fused silica, silicates, glass beads, and mica). Particulate fillers can be in the form of flakes, rods, spheres, and the like.

The amount and type of such additives may be selected by one skilled in the art, depending on the intended end use of the composition.

In select embodiment, the polymeric material further comprises at least one amine, at least one molecule of the at least one amine having an average amine functionality of 2.0 or greater, wherein each amine is a primary amine or a secondary amine. The at least one amine acts as a curative and can be mixed with the polymeric material when it is desirable to begin curing. Suitable amines are discussed in detail below with respect to two-part compositions.

In certain embodiments, the polymeric material is used in an application where it is disposed between two substrates, wherein solvent removal (e.g., evaporation) is restricted, especially when one or more of the substrates comprises a moisture impermeable material (e.g., steel or glass). In such cases, the polymeric material comprises a solids content of 90% or greater, 92% or greater, 94% or greater, 95% or greater, 96% or greater, 98% or greater, or 99% or greater. Likewise, in such embodiments where solvent removal is restricted, the first part, the second part, or both parts of a two-part composition according to the present disclosure comprises a solids content of 90% or greater, 92% or greater, 94% or greater, 95% or greater, 96% or greater, 98% or greater, or 99% or greater. Components that are considered “solids” include, for instance and without limitation, polymers, oligomers, monomers, hydroxyl-containing compounds, and additives such as plasticizers, catalysts, non-reactive diluents, and fillers. Typically, only solvents do not fall within the definition of solids, for instance water or organic solvents.

For convenient handleability, the polymeric material typically comprises a dynamic viscosity of 10 Poise (P) or greater as determined using a Brookfield viscometer, 50 P or greater, 100 P or greater, 150 P or greater, 250 P or greater, 500 P or greater, 1,000 P or greater, 1,500 P or greater, 2,000 P or greater, 2,500 P or greater, or even 3,000 P or greater; and 10,000 P or less, 9,000 P or less, 8,000 P or less, 7,000 P or less, 6,000 P or less, 5,000 P or less, or even 4,000 P or less, as determined using a Brookfield viscometer. Stated another way, the polymeric material may exhibit a dynamic viscosity of 10 Poise (P) to 10,000 P, inclusive, 10 P to 6,000 P, or 10 P to 4,000 P, inclusive, as determined using a Brookfield viscometer. Conditions for the dynamic viscosity test include use of a LV4 spindle at a speed of 0.3 or 0.6 revolutions per minute (RPM) at 24 degrees Celsius.

The polymerizable compositions are often in the form of a two-part composition. Hence, in a second aspect, a two-part composition is provided. The two-part composition includes (a) a first part including a polymeric material and (b) a second part including at least one amine. At least one molecule of the at least one amine has an average amine functionality of 2.0 or greater, and each amine is a primary amine or a secondary amine. The polymeric material includes a polymerized reaction product of a polymerizable composition including components and has a solids content of 90% or greater. The components include (i) a uretdione-containing material including a reaction product of a diisocyanate reacted with itself; (ii) a first hydroxyl-containing compound having more than one OH group; (iii) an optional second hydroxyl-containing compound having a single OH group, wherein the second hydroxyl-containing compound is a primary alcohol or a secondary alcohol; and (iv) an epoxy component. The epoxy component is present in an amount of 35% by weight or greater, based on the total weight of the polymerizable composition. Stated another way, the two-part composition includes:
(a) a first part comprising a polymeric material comprising:
   a polymerized reaction product of a polymerizable composition comprising components, the components comprising:
   (i) a uretdione-containing material comprising a reaction product of a diisocyanate reacted with itself;
   (ii) a first hydroxyl-containing compound having more than one OH group;
   (iii) an optional second hydroxyl-containing compound having a single OH group, wherein the second hydroxyl-containing compound is a primary alcohol or a secondary alcohol;
   and
   (iv) an epoxy component in an amount of 35% by weight or greater, based on the total weight of the polymerizable composition;
   wherein the polymeric material comprises a solids content of 90% or greater; and
(b) a second part comprising at least one amine, at least one molecule of the at least one amine having an average amine functionality of 2.0 or greater, wherein each amine is a primary amine or a secondary amine.

Two-part compositions according to the present disclosure use the basic chemical reaction from Scheme 3 below, i.e., a polymeric material comprising a uretdione-containing material and an epoxy component in one part of the system and a multifunctional amine in the other part of the system. When the amine curative is mixed with the uretdione-containing material and epoxy component, the amine opens the uretdione to form a biuret and opens the epoxy ring. This produces an isocyanate-free coating or adhesive system according to Scheme 3:

### Scheme 3

Advantageously, the same amine curatives and catalysts are typically effective in reacting and catalyzing, respectively, both uretdione functional groups and epoxy functional groups. The

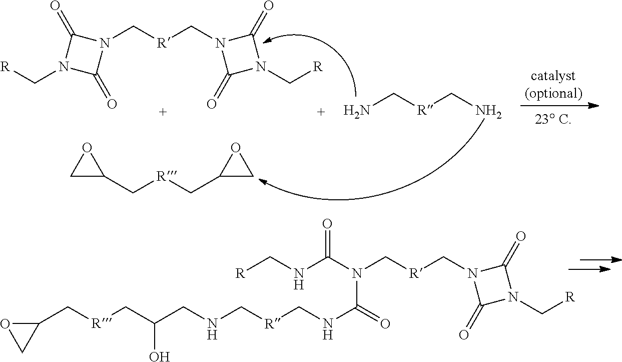

amount of amine curative can be controlled relative to the combined amount of epoxy component and uretdione functional groups to achieve a (e.g., fully) cured system, depending on the characteristics of the amine curative. For instance, the higher a primary amine content, the less amine curative required.

In certain embodiments, some steric hindrance of the amine is helpful to decrease the reaction rate to a suitable speed for essentially complete reaction of the first part with the second part. The average functionality of the amine is relevant, thus the second part can include a mixture of amines with different functionalities as long as the average is 2.0 or greater. Preferably, the average functionality (e.g., of at least one molecule of the amine) is greater than 2.0 (such as 2.2 or greater, 2.4 or greater, 2.6 or greater, 2.8 or greater, or 3.0 or greater); and 4.0 or less, 3.9 or less, 3.8 or less, 3.7 or less, or 3.6 or less. Moreover, if the amine is not sufficiently miscible with the first part of the two-part composition, (e.g., tends to separate from the first part upon mixture of the first part and the second part of a two-part composition), then that amine is not suitable for reaction with that first part. It has been found that in embodiments with a high amount of epoxy component (e.g., 35 wt. % or greater) enables the use of more primary aliphatic amines (e.g., an amine group located on an alkane group), which would otherwise react too swiftly with uretdione-containing materials to allow essentially complete reaction of the two-part composition if a lower amount of the epoxy component was present.

The polymerized reaction product (of the polymeric material) also needs to have enough of a uretdione group functionality per molecule of polymerized reaction product to allow for curing of a two-part composition into an effective polymer network when reacted with an amine. Typically, the polymerized reaction product comprises an average of 1.3 to 6.0 inclusive, of a uretdione functional group in a backbone of the polymerized reaction product. It is usually advantageous for the first part (e.g., the polymeric material) to be flowable, (e.g., to allow for mixing with the second part) and to readily wet the surface of either a substrate to be coated or two substrates to be adhered. To provide a uretdione-containing polymeric material that has a relatively low viscosity at a high solids content, the composition of the polymerized reaction product should have minimal crystallinity, which can be achieved through the inclusion of the reactive diluent epoxy component. In published reports, uretdione-containing materials used in solvent-borne coatings have had a molecular weight that is too high be practical in the adhesive systems having 90% or greater solids content without also including an epoxy component. Further, it has been found that the amount of diol in a first part of a two-part composition can be included in a range of about 0.2 to 0.65 equivalents relative to the isocyanate equivalents to achieve a suitable viscosity and a sum of the OH equivalents of the first hydroxyl-containing compound and the optional second hydroxyl-containing compound is equal to or greater than the isocyanate equivalents of the polymerized reaction product.

Polymeric materials according to the present disclosure should be paired with second parts having amines with a functionality that is greater than 2.0, to produce better properties, such as adhesive strength and gel content. Previous reports, for instance, teach that primary amines give a rapid cure of uretdione-containing material that limits pot life, and it has been found that that is the case with certain amines, such as diethylenetriamine and other ethylenediamine oligomers. Interestingly, it has been found that polymeric materials according to the present disclosure cure to a soft, poorly crosslinked material when cured with certain diamines. However, it has also been found that amine-terminated polyethers (e.g., available under the trade name “JEFFAMINE” commercially available from Huntsman (The Woodlands, Tex.)) produce an acceptable rate of cure, particularly when they are primary amines. Trifunctional JEFFAMINE amines, such as JEFFAMINE T403, have been found to produce particularly good performance in adhesive systems according to the present disclosure. Difunctional JEFFAMINE amines, such as JEFFAMINE D230, D400, AND THF-100, have also been found to produce good performance in adhesive systems according to the present disclosure. Extremely high molecular weight amines tend to not provide good miscibility with the polymeric material of the first part, however, and the apparent phase separation of the uretdione-containing material and the amine curing agent tends to prevent effective cure. The relatively high molecular weight of JEFFAMINE curing agents provide another advantage over small-molecule diamines: the JEFFAMINES require a weight ratio between the curing agent and the uretdione-containing material that is higher, and a balanced mixture ratio (e.g., the more closely it approaches 50 wt. % of each component) is often more convenient for two-part compositions.

The one or more amines present in the second part preferably have an average amine functionality of 2.0 or greater, 2.1 or greater, 2.2 or greater, 2.3 or greater, 2.4 or greater, 2.5 or greater, 2.6 or greater, 2.7 or greater, 2.8 or greater, 2.9 or greater, 3.0 or greater, 3.1 or greater, 3.2 or greater, 3.3 or greater, 3.4 or greater, or even 3.5 or greater; and an average amine functionality of 4.0 or less. The average amine functionality of 2.0 or greater tends to result in more desirable properties of the polymerized product after curing with the amine curing agent, such as gel content and adhesive strength. Moreover, the average amine functionality may be selected based on whether a desired application requires, e.g., stiffness versus elasticity; or high T_{g} versus low T_{g}. The “average amine functionality” is the average number of primary or secondary amine nitrogen atoms per molecule.

In certain embodiments, the second part includes a diamine or a triamine, such as a difunctional amine-terminated polyether or a trifunctional amine-terminated polyether, respectively. Another suitable amine for use in the second part comprises a phenalkamine, 4,7,10-trioxatridecane-1,13-diamine, or a reaction product of epichlorohydrin with 1,3-benzenedimethanamine. For instance, a reaction product of epichlorohydrin with 1,3-benzenedimethanamine is commercially available under the trade designation GASKAMINE 328 from Mitsubishi Gas Chemical Company (New York, N.Y.). Exemplary amines include for instance, solvent-free phenalkamine available under the trade designation CARDOLITE 5607 from Cardolite Corporation (Monmouth Junction, N.J.) and a reactive liquid polyamide available under the trade designation ANCAMIDE 350A from Evonik Industries (Essen, Germany).

The at least one amine often comprises a molecular weight of 2,000 grams per mole (g/mole) or less, 1,800 g/mole or less, 1,600 g/mole or less, 1,500 g/mole or less, 1,400 g/mole or less, 1,200 g/mole or less, or even 1,000 g/mole or less.

The amount of amine included may be selected based on the amount of uretdione-containing material and optionally also epoxy material present in the first part. For instance, a number of equivalents of uretdione can be 95% or less, 90% or less, 85% or less, 80% or less, 75% or less, or 70% or less, of a number of amine equivalents; and a number of equivalents of uretdione can be 50% or more or 55% or more, than a number of amine equivalents. Similarly, a number of equivalents of uretdione and epoxy can be less than 250%, 200% or less, 180% or less, 165% or less, or 155% or less, of a number of amine hydrogen equivalents; and a number of equivalents of uretdione and epoxy can be 10% or greater, 15% or greater, 20% or greater, 25% or greater, or 30% or greater, than the number of amine hydrogen equivalents. In an embodiment, the number of equivalents of uretdione and epoxy is between 25% and 155% of the number of amine hydrogen equivalents. The number of equivalents of uretdione in the polymeric material can be calculated using the method described in detail in the Examples below.

In some embodiments, the second part (and optionally the first part) further includes a catalyst selected from bismuth neodecanoate, bismuth ethylhexanoate, calcium triflate, calcium nitrate, 1,8-diazabicyclo[5.4.0]undec-7-ene, tris-(dimethylaminomethyl) phenol, and combinations thereof. One or more of these catalysts can be useful in catalyzing a reaction of components of the first part with the second part.

It has been discovered that it is possible to provide two-part compositions (according to at least certain embodiments of the present disclosure) that are 90% or greater solids and exhibit each of 1) good flowability; 2) acceptable extent of cure; and 3) curing in a relatively short amount of time. Adhesive two-part compositions can further exhibit 4) acceptable adhesion strength following curing.

For convenient handleability, the second part typically comprises a dynamic viscosity of 0.1 Poise (P) or greater as determined using a Brookfield viscometer, 1 P or greater, 5 P or greater, 10 P or greater, 25 P or greater, 50 P or greater, 75 P or greater, 100 P or greater, 150 P or greater, 200 P or greater, or even 250 P or greater; and 5,000 P or less, 4,000 P or less, 3,000 P or less, 2,000 P or less, 1,000 P or less, 750 P or less, or even 500 P or less, as determined using a Brookfield viscometer. Stated another way, the second part may exhibit a viscosity of 0.1 Poise (P) to 5,000 P, inclusive, or 0.1 P to 1,000 P, inclusive, as determined using a Brookfield viscometer (such as with the measurement conditions described above).

The uretdione-containing material is typically kept separate from the curing agent prior to use of the polymerizable composition. That is, the uretdione-containing material is typically in a first part and the amine curing agent is typically in a second part of the polymerizable composition. The first part can include other components that do not react with the uretdione-containing material (or that react with only a portion of the uretdione-containing material). Likewise, the second part can include other components that do not react with the amine curing agent or that react with only a portion of the amine curing agent. When the first part and the second part are mixed together, the various components react to form the reaction product, for instance as shown below in the general reaction Scheme 4, in which the optional second hydroxyl group is present:

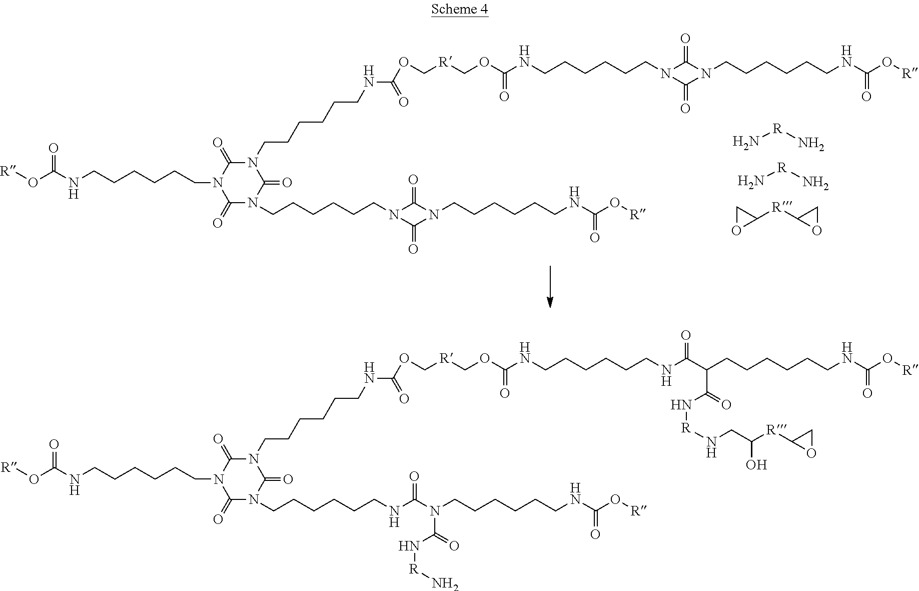

After mixing of the first part and the second part, the two-part composition gels, reaches a desired handling strength, and ultimately achieves a desired final strength. Some two-part compositions must be exposed to elevated temperatures to cure, or at least to cure within a desired time. However, it may be desirable to provide structural adhesives that do not require heat to cure (e.g., room temperature curable adhesives), yet still provide high performance in peel, shear, and impact resistance. As used herein, “gel time” refers to the time required for the mixed components to reach the gel point. As used herein, the “gel point” is the point where the mixture's storage modulus exceeds its loss modulus. “Handling strength” refers to the ability of the adhesive to cure to the point where the bonded parts can be handled in subsequent operations without destroying the bond. The required handling strength varies by application. As used herein, “initial cure time” refers to the time required for the mixed components to reach an overlap shear adhesion of 0.34 MPa (50 psi); which is a typical handling strength target. Advantageously, the use of uretdione-containing compositions in conjunction with high amount of epoxy component (e.g., 35 wt. % or greater) can decrease the initial cure time and the gel time without decreasing performance characteristics of the final polymerized product relative to epoxy compositions without uretdione-containing compositions.

In a third aspect, a polymerized product is provided. The polymerized product is the polymerized product of any of the two-part compositions according to the second aspect described above. The polymerized product typically coats at least a portion of a substrate, and up to the entire surface of a substrate depending on the application. When the polymerized product acts as an adhesive, often the polymerized product is disposed between two substrates (e.g., adhering the two substrates together). Advantageously, the polymerized product of at least some embodiments of the disclosure is suitable for use when at least one substrate comprises a moisture impermeable material, due to the high solids content of the polymerizable composition. Hence, in certain embodiments at least one substrate is made of a metal (e.g., steel), a glass, a wood, a ceramic, or a polymeric material. The polymerized product may also be employed with one or more substrates that have moisture permeability, for instance but without limitation, woven materials, nonwoven materials, paper, foams, membranes, and polymeric films.

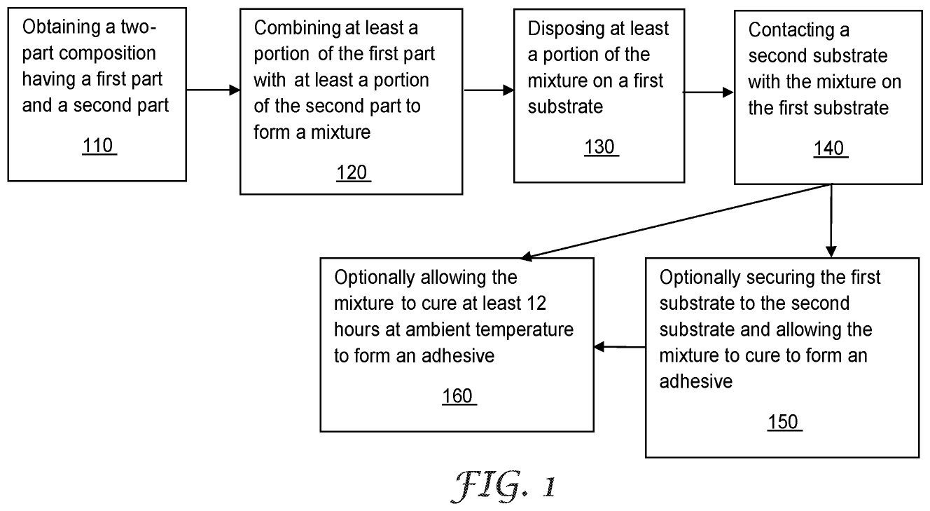

In a fourth aspect, a method of adhering two substrates is provided. Referring to FIG. 1, the method includes obtaining a two-part composition 110; combining at least a portion of the first part with at least a portion of the second part to form a mixture 120; disposing at least a portion of the mixture on a first major surface of a first substrate 130; and contacting a first major surface of a second substrate with the mixture disposed on the first substrate 140. The two-part composition includes (i) a first part including a polymeric material and (ii) a second part including at least one amine. At least one molecule of the at least one amine has an average amine functionality of 2.0 or greater, and each amine is a primary amine or a secondary amine. The polymeric material includes a reaction product of a polymerizable composition including components. The components include (1) a uretdione-containing material including a reaction product of a diisocyanate reacted with itself; (2) a first hydroxyl-containing compound having more than one OH group; (3) an optional second hydroxyl-containing compound having a single OH group, wherein the second hydroxyl-containing compound is a primary alcohol or a secondary alcohol; and (4) an epoxy component. The epoxy component is present in an amount of 35% by weight or greater, based on the total weight of the polymerizable composition. The polymeric material has a solids content of 90% or greater.

Referring again to FIG. 1, the method optionally further comprises securing the first substrate to the second substrate (e.g., with one or more mechanical clamps, under a weighted object, etc.) and allowing the mixture to cure to form an adhesive adhering the first substrate and the second substrate together 150. The method optionally further comprises allowing the mixture to cure for at least 12 hours at ambient temperature to form an adhesive adhering the first substrate and the second substrate together 160. In contrast to some other available two-part compositions that are recommended to be allowed to cure for at least 24 hours (or at least 2 days, at least 4 days, at least 7 days, or at least 2 weeks), the present disclosure provides two-part compositions that are allowed to cure for 10 hours or more, 12 hours or more, 14 hours or more, 16 hours or more, or 18 hours or more; and up to 30 hours, up to 28 hours, up to 26 hours, up to 24 hours, up to 22 hours, or up to 20 hours. In some embodiments, the mixture of the first part and the second part is allowed to cure for 10 to 22 hours or 12 to 20 hours.

Stated another way, a method of adhering two substrates together comprises:
(a) obtaining a two-part composition, the two-part composition comprising:
   (i) a first part comprising:
      a polymeric material comprising a reaction product of a polymerizable composition comprising components, the components comprising:
      (1) a uretdione-containing material comprising a reaction product of a diisocyanate reacted with itself;
      (2) a first hydroxyl-containing compound having more than one OH group;
      (3) an optional second hydroxyl-containing compound having a single OH group, wherein the second hydroxyl-containing compound is a primary alcohol or a secondary alcohol; and
      (4) an epoxy component in an amount of 35% by weight or greater, based on the total weight of the polymerizable composition;
wherein the polymeric material comprises a solids content of 90% or greater; and
   (ii) a second part comprising at least one amine, at least one molecule of the at least one amine having an average amine functionality of 2.0 or greater wherein each amine is a primary amine or a secondary amine;
(b) combining at least a portion of the first part with at least a portion of the second part to form a mixture;
(c) disposing at least a portion of the mixture on a first major surface of a first substrate; and
(d) contacting a first major surface of a second substrate with the mixture disposed on the first substrate.

Depending on the particular application, an amount of each of the first part and the second part obtained will vary; in certain embodiments, an excess of one or both of the first part and the second part is obtained and hence only a portion of one or both of the first part and the second part, respectively, will be combined to form a mixture. In other embodiments, however, a suitable amount of each of the first part and the second part for adhering the first and second substrates together is obtained and essentially all of the first part and the second part is combined to form the mixture. In certain embodiments, combining a (e.g., predetermined) amount of the first part with a (e.g., predetermined) amount of the second part is performed separately from the first and second substrates, while in other embodiments the combining is performed (e.g., directly) on the first major surface of a substrate.

The mixture is typically applied to (e.g., disposed on) the surface of the substrate using conventional techniques such as, for example, dispensing, bar coating, roll coating, curtain coating, rotogravure coating, knife coating, spray coating, spin coating, or dip coating techniques. Coating techniques such as bar coating, roll coating, and knife coating are often used to control the thickness of a layer of the mixture. In certain embodiments, the disposing comprises spreading the mixture on the first major surface of the first substrate, for instance when the mixture is dispensed (e.g., with a nozzle, etc.) on the surface of the substrate such that the mixture does not cover the entirety of a desired area.

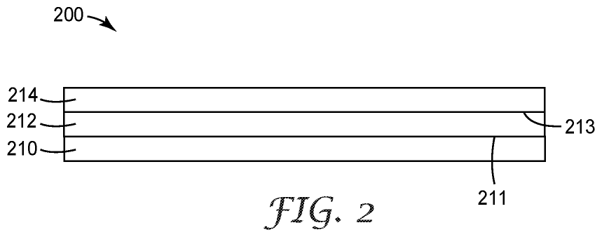

Referring to FIG. 2, a schematic cross-section of an article 200 is illustrated. The article 200 comprises a mixture 212 (e.g., an adhesive) disposed on a first major surface 211 of a first substrate 210. The article 200 further comprises a first major surface 213 of a second substrate 214 in contact with (e.g., adhered to) the mixture 212 disposed on the first substrate 210.

Advantageously, the two-part compositions according to at least certain embodiments of the present disclosure are capable of providing at least a minimum adhesion of two substrates together. Following cure, the adhesive preferably exhibits a minimum overlap shear on aluminum of 0.3 megaPascals (MPa), 1 MPa, 5 MPa, 10 MPa, 12 MPa, 15 MPa, 20 MPa, 25 MPa, 30 MPa, 40 MPa, or 50 MPa. A suitable test for determining the minimum overlap shear is described in the Examples below.

In a fifth aspect, a method of making a two-part composition is provided. The method includes providing a first part by forming a polymeric material including a reaction product of a polymerizable composition; and providing a second part including at least one amine. At least one molecule of the at least one amine has an average amine functionality of 2.0 or greater, and each amine is a primary amine or a secondary amine. The polymeric material includes a polymerized reaction product of a polymerizable composition including components. The components include (i) a uretdione-containing material including a reaction product of a diisocyanate reacted with itself; (ii) a first hydroxyl-containing compound having more than one OH group; (iii) an optional second hydroxyl-containing compound having a single OH group, wherein the second hydroxyl-containing compound is a primary alcohol or a secondary alcohol; and (iv) an epoxy component. The epoxy component is present in an amount of 35% by weight or greater, based on the total weight of the polymerizable composition. The polymeric material has a solids content of 90% or greater.

Stated another way, a method of making a two-part composition comprises:
(a) obtaining a two-part composition, the two-part composition comprising:
   (i) a first part comprising:
      a polymeric material comprising a reaction product of a polymerizable composition comprising components, the components comprising:
         (1) a uretdione-containing material comprising a reaction product of a diisocyanate reacted with itself;
         (2) a first hydroxyl-containing compound having more than one OH group;
         (3) an optional second hydroxyl-containing compound having a single OH group, wherein the second hydroxyl-containing compound is a primary alcohol or a secondary alcohol; and
         (4) an epoxy component in an amount of 35% by weight or greater, based on the total weight of the polymerizable composition;
wherein the polymeric material comprises a solids content of 90% or greater; and
   (ii) a second part comprising at least one amine, at least one molecule of the at least one amine having an average amine functionality of 2.0 or greater wherein each amine is a primary amine or a secondary amine;
(b) combining at least a portion of the first part with at least a portion of the second part to form a mixture;
(c) disposing at least a portion of the mixture on a first major surface of a first substrate; and
(d) contacting a first major surface of a second substrate with the mixture disposed on the first substrate.

The amine of the second part is as described above with respect to the fourth aspect.

### Select Embodiments of the Disclosure

Embodiment 1 is a polymeric material comprising:
a polymerized reaction product of a polymerizable composition comprising components, the components comprising:
   (a) a uretdione-containing material comprising a reaction product of a diisocyanate reacted with itself;
   (b) a first hydroxyl-containing compound having more than one OH group;
   (c) an optional second hydroxyl-containing compound having a single OH group, wherein the second hydroxyl-containing compound is a primary alcohol or a secondary alcohol; and
   (d) an epoxy component in an amount of 35% by weight or greater, based on the total weight of the polymerizable composition;
   wherein the polymeric material comprises a solids content of 90% or greater.

Embodiment 2 is the polymeric material of embodiment 1, wherein components (a), (b), and, if present, (c), are reacted, and then component (d) is combined with the reaction product of components (a), (b), and, if present, (c).

Embodiment 3 is the polymeric material of embodiment 1, wherein component (d) is present at the time of reaction of components (a), (b), and, if present, (c).

Embodiment 4 is the polymeric material of any of embodiments 1 to 3, wherein the second hydroxyl-containing compound is present and is an alkyl alcohol, a polyester alcohol, or a polyether alcohol.

Embodiment 5 is the polymeric material of any of embodiments 1 to 4, wherein the first hydroxyl-containing compound is an alkylene polyol, a polyester polyol, or a polyether polyol.

Embodiment 6 is the polymeric material of any of embodiments 1 to 5, wherein the uretdione-containing material comprises a compound of Formula I:

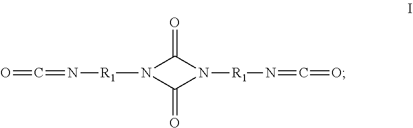

wherein R₁ is independently a C₄ to C₁₄ alkylene, arylene, and alkaralyene.

Embodiment 7 is the polymeric material of any of embodiments 1 to 6, wherein the second hydroxyl-containing compound is present and is of Formula VII:

R₁₃—OH VII;

wherein R₁₃ is selected from R₁₄, R₁₅, and a C₁ to C₅₀ alkyl;

wherein R₁₄ is of Formula VIII:

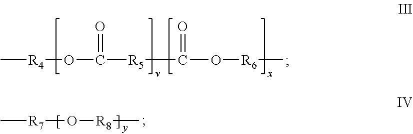

wherein m=1 to 20, R₁₆ is an alkyl, and R₁₇ is an alkylene;

wherein R₁₅ is of Formula IX:

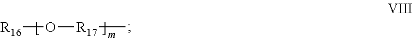

wherein n=1 to 20, R₁₈ is an alkyl, and R₁₉ is an alkylene.

Embodiment 8 is the polymeric material of any of embodiments 1 to 7, wherein the first hydroxyl-containing compound is of Formula II:

HO—R₂—OH II;

wherein R₂ is selected from R₃, an alkylene, and an alkylene substituted with an OH group, wherein R₃ is of Formula III or Formula IV:

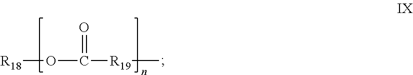

wherein each of R₄, R₅, R₆, R₇, and R₈ is independently an alkylene, wherein each of v and y is independently 1 to 40, and wherein x is selected from 0 to 40.

Embodiment 9 is the polymeric material of embodiment 8, wherein R₂ is selected from a C₁ to C₂₀ alkylene and a C₁ to C₂₀ alkylene substituted with an OH group.

Embodiment 10 is the polymeric material of embodiment 8 or embodiment 9, wherein each of R₄, R₅, R₆, R₇, and R₈ is independently a C₁ to C₂₀ alkylene.

Embodiment 11 is the polymeric material of any of embodiments 1 to 7, wherein the first hydroxyl-containing compound is of Formula V or Formula VI:

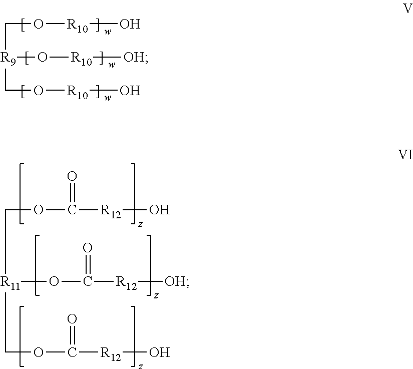

wherein each of R₉ and R₁₁ is independently an alkane-triyl, wherein each of R₁₀ and R₁₂ is independently an alkylene and wherein each of w and z is independently 1 to 20.

Embodiment 12 is the polymeric material of embodiment 11, wherein each of R₁₀ and R₁₂ is independently a C₁ to C₂₀ alkylene.

Embodiment 13 is the polymeric material of any of embodiments 1 to 12, comprising greater than one uretdione functional group in a backbone of the polymeric material.

Embodiment 14 is the polymeric material of any of embodiments 1 to 13, comprising an average of 1.3 to 6.0, inclusive, of a uretdione functional group in a backbone of the polymerized reaction product.

Embodiment 15 is the polymeric material of any of embodiments 1 to 14, comprising an average of 1.5 to 4.0, inclusive, of a uretdione functional group in a backbone of the polymerized reaction product.

Embodiment 16 is the polymeric material of any of embodiments 1 to 15, comprising a solids content of 94% or greater.

Embodiment 17 is the polymeric material of any of embodiments 1 to 16, comprising a solids content of 98% or greater.

Embodiment 18 is the polymeric material of any of embodiments 1 to 17, comprising an average of 0.2 to 18, inclusive, of a carbamate functional group in a backbone of the polymerized reaction product.

Embodiment 19 is the polymeric material of any of embodiments 1 to 18, wherein the polymeric material is essentially free of isocyanates.

Embodiment 20 is the polymeric material of any of embodiments 1 to 19, wherein the diisocyanate comprises hexamethylene diisocyanate.

Embodiment 21 is the polymeric material of any of embodiments 1 to 20, further comprising a catalyst.

Embodiment 22 is the polymeric material of embodiment 19, wherein the catalyst comprises a bismuth carboxylate.

Embodiment 23 is the polymeric material of embodiment 22, wherein the bismuth carboxylate is bismuth neodecanoate.

Embodiment 24 is the polymeric material of embodiment 22, wherein the bismuth carboxylate is bismuth ethylhexanoate.

Embodiment 25 is the polymeric material of any of embodiments 1 to 24, wherein the polymerized reaction product comprises an average of 1.3 or fewer isocyanurate units per molecule of the polymerized reaction product.

Embodiment 26 is the polymeric material of any of embodiments 1 to 19 or 21 to 25, wherein the diisocyanate comprises a functional group selected from Formula X, Formula XI, and Formula XII:

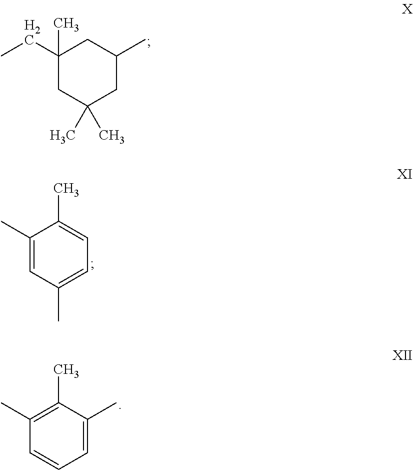

Embodiment 27 is the polymeric material of any of embodiments 1 to 26, comprising a dynamic viscosity of 10 Poise (P) to 10,000 P, inclusive, as determined using a Brookfield viscometer.

Embodiment 28 is the polymeric material of any of embodiments 1 to 27, comprising a dynamic viscosity of 10 P to 6,000 P, inclusive, or 10 P to 4,000 P, inclusive, as determined using a Brookfield viscometer.

Embodiment 29 is the polymeric material of any of embodiments 1 to 28, further comprising a plasticizer, a non-reactive diluent, or a combination thereof.

Embodiment 30 is the polymeric material of any of embodiments 1 to 29, wherein the epoxy component comprises at least one monofunctional epoxy.

Embodiment 31 is the polymeric material of any of embodiments 1 to 30, wherein the epoxy component comprises at least one multifunctional epoxy.

Embodiment 32 is the polymeric material of any of embodiments 1 to 31, wherein the epoxy component comprises at least one trifunctional epoxy.

Embodiment 33 is the polymeric material of any of embodiments 1 to 32, wherein the epoxy component comprises at least one glycidyl ether group.

Embodiment 34 is the polymeric material of any of embodiments 1 to 33, wherein the epoxy component has a molecular weight of 2,000 grams per mole or less.

Embodiment 35 is the polymeric material of any of embodiments 1 to 34, wherein the epoxy component exhibits a dynamic viscosity of 100,000 centipoises (cP) or less, 50,000 cP or less, or 20,000 cP or less, as determined using a Brookfield viscometer.

Embodiment 36 is the polymeric material of any of embodiments 1 to 35, wherein the epoxy component comprises an aliphatic epoxy.

Embodiment 37 is the polymeric material of any of embodiments 1 to 36, wherein the epoxy component is present in an amount of 35% to 95% by weight, based on the total weight of the polymerizable composition, and wherein the epoxy component comprises a polyglycidyl ether of a polyhydric phenol, preferably a polyglycidyl ether of bisphenol A, bisphenol F, bisphenol AD, catechol, or resorcinol.

Embodiment 38 is the polymeric material of any of embodiments 1 to 37, wherein the epoxy component is present in an amount of 35% to 95% by weight, based on the total weight of the polymerizable composition, and wherein the epoxy component comprises an epoxidised (poly)olefinic resin, an epoxidised phenolic novolac resin, an epoxidised cresol novolac resin, or a combination thereof.

Embodiment 39 is the polymeric material of any of embodiments 1 to 38, wherein the epoxy component is present in an amount of 50% to 80% by weight or 60% to 75% by weight, based on the total weight of the polymerizable composition.

Embodiment 40 is the polymeric material of any of embodiments 1 to 39, further comprising at least one additive selected from a toughening agent, a filler, a flow control agent, an adhesion promoter, a colorant, a UV stabilizer, a flexibilizer, a fire retardant, an antistatic material, a thermally and/or electrically conductive particle, or an expanding agent.

Embodiment 41 is the polymeric material of any of embodiments 1 to 40, wherein the second hydroxyl-containing compound is present and is selected from 2-butanol, 2-ethyl-1-hexanol, isobutanol, and 2-butyl-octanol.

Embodiment 42 is the polymeric material of any of embodiments 1 to 41, wherein the first hydroxyl-containing compound is selected from 2,2-dimethyl-1,3-propanediol, 2-methyl-1,3-propanediol, diethylene glycol, poly(tetramethylene ether) glycol, 2-ethylhexane-1,3-diol, and 1,3-butanediol.

Embodiment 43 is the polymeric material of any of embodiments 1 to 10 or 13 to 42, wherein the second hydroxyl-containing compound is present and is of Formula VII and the first hydroxyl-containing compound is of Formula II, wherein R₂ of the compound of Formula II is of Formula III, and wherein R₁₃ of the compound of Formula VII is a branched C₄ to C₂₀ alkyl.

Embodiment 44 is the polymeric material of any of embodiments 1 to 43, wherein a sum of the OH equivalents of the first hydroxyl-containing compound and the second hydroxyl-containing compound is equal to or greater than the isocyanate equivalents of the polymeric material.

Embodiment 45 is the polymeric material of any of embodiments 1 to 44, further comprising at least one amine, at least one molecule of the at least one amine having an average amine functionality of 2.0 or greater, wherein each amine is a primary amine or a secondary amine.

Embodiment 46 is the polymeric material of any of embodiments 1 to 45, wherein the first hydroxyl-containing compound is a diol and the reaction product comprises 0.2 to 0.65, inclusive, of diol equivalents relative to isocyanate equivalents.

Embodiment 47 is the polymeric material of any of embodiments 1 to 46, wherein the first hydroxyl-containing compound is a diol and the reaction product comprises 0.25 to 0.61, inclusive, of diol equivalents relative to isocyanate equivalents.

Embodiment 48 is the polymeric material of any of embodiments 1 to 47, wherein the first hydroxyl-containing compound comprises a branched diol.

Embodiment 49 is the polymeric material of any of embodiments 1 to 48, wherein the second hydroxyl-containing compound is present and comprises a branched alcohol.

Embodiment 50 is the polymeric material of any of embodiments 1 to 49, wherein the second hydroxyl-containing compound is present and comprises a secondary alcohol.

Embodiment 51 is the polymeric material of any of embodiments 1 to 3, 5, 6, 8 to 40, 42, or 44 to 48, comprising an average of 1.3 to 5.0, inclusive, of a uretdione functional group in a backbone of the polymeric material and wherein the polymerizable composition is free of the second hydroxyl-containing compound.

Embodiment 52 is a two-part composition comprising:
(a) a first part comprising a polymeric material of any of embodiments 1 to 51; and
(b) a second part comprising at least one amine, at least one molecule of the at least one amine having an average amine functionality of 2.0 or greater, wherein each amine is a primary amine or a secondary amine.

Embodiment 53 is the two-part composition of embodiment 52, wherein at least one molecule of the at least one amine has an average amine functionality of 4.0 or less.

Embodiment 54 is the two-part composition of embodiment 52 or embodiment 53, wherein the at least one amine has an average amine functionality of 2.4 or greater.

Embodiment 55 is the two-part composition of any of embodiments 52 to 54, wherein the at least one amine comprises a primary amine comprising a phenalkamine, 4,7,10-trioxatridecane-1,13-diamine, a reaction product of epichlorohydrin with 1,3-benzenedimethanamine, or combinations thereof.

Embodiment 56 is the two-part composition of any of embodiments 52 to 55, wherein the at least one amine comprises a triamine.

Embodiment 57 is the two-part composition of any of embodiments 52 to 56, wherein the at least one amine comprises an amine-terminated polyether.

Embodiment 58 is the two-part composition of any of embodiments 52 to 57, wherein the at least one amine comprises a difunctional or trifunctional amine-terminated polyether.

Embodiment 59 is the two-part composition of any of embodiments 52 to 58, wherein the at least one amine comprises a reaction product of epichlorohydrin with 1,3-benzenedimethanamine.

Embodiment 60 is the two-part composition of any of embodiments 52 to 59, wherein the at least one amine comprises a molecular weight of 2,000 grams per mole or less.

Embodiment 61 is the two-part composition of any of embodiments 52 to 60, wherein the second part comprises a solids content of 90% or greater, 94% or greater, or 98% or greater.

Embodiment 62 is the two-part composition of any of embodiments 52 to 61, wherein the second part comprises a viscosity of 0.1 Poise (P) to 5,000 P, inclusive, or 0.1 Poise (P) to 1,000 P, inclusive, as determined using a Brookfield viscometer.

Embodiment 63 is a two-part composition of any of embodiments 52 to 62, wherein a number of equivalents of uretdione is less than 60% of a number of epoxy equivalents.

Embodiment 64 is a two-part composition of any of embodiments 52 to 63, wherein a number of equivalents of uretdione is 55% or less, 50% or less, or 46% or less, of a number of epoxy equivalents.

Embodiment 65 is a two-part composition of any of embodiments 52 to 64, wherein a number of equivalents of uretdione is greater than 3% of a number of epoxy equivalents.

Embodiment 66 is a two-part composition of any of embodiments 52 to 65, wherein a number of equivalents of uretdione and epoxy is 250% or less, 200% or less, 180% or less, or 165% or less, of a number of amine hydrogen equivalents.

Embodiment 67 is a two-part composition of any of embodiments 52 to 66, wherein a number of equivalents of uretdione and epoxy is 10% or greater, 15% or greater, 20% or greater, 25% or greater, or 30% or greater, of a number of amine hydrogen equivalents.

Embodiment 68 is a two-part composition of any of embodiments 52 to 67, wherein the number of equivalents of uretdione and epoxy is between 25% and 155% of the number of amine hydrogen equivalents.

Embodiment 69 is a polymerized product of the two-part composition of any of embodiments 52 to 68.

Embodiment 70 is the polymerized product of embodiment 69, wherein the polymerized product coats at least a portion of a substrate.

Embodiment 71 is the polymerized product of embodiment 69 or embodiment 70, wherein the polymerized product is disposed between two substrates.

Embodiment 72 is the polymerized product of embodiment 70 or embodiment 71, wherein at least one substrate comprises a moisture impermeable material.

Embodiment 73 is the polymerized product of any of embodiments 70 to 72, wherein at least one substrate is made of a metal.

Embodiment 74 is a method of adhering two substrates together, the method comprising:
(a) obtaining a two-part composition, the two-part composition comprising:
   (i) a first part comprising:
      a polymeric material comprising a reaction product of a polymerizable composition comprising components, the components comprising:
         (1) a uretdione-containing material comprising a reaction product of a diisocyanate reacted with itself;
         (2) a first hydroxyl-containing compound having more than one OH group;
         (3) an optional second hydroxyl-containing compound having a single OH group, wherein the second hydroxyl-containing compound is a primary alcohol or a secondary alcohol; and
         (4) an epoxy component in an amount of 35% by weight or greater, based on the total weight of the polymerizable composition;
         wherein the polymeric material comprises a solids content of 90% or greater; and
   (ii) a second part comprising at least one amine, at least one molecule of the at least one amine having an average amine functionality of 2.0 or greater wherein each amine is a primary amine or a secondary amine;
(b) combining at least a portion of the first part with at least a portion of the second part to form a mixture;
(c) disposing at least a portion of the mixture on a first major surface of a first substrate; and
(d) contacting a first major surface of a second substrate with the mixture disposed on the first substrate.

Embodiment 75 is the method of embodiment 74, further comprising securing the first substrate to the second substrate and allowing the mixture to cure to form an adhesive adhering the first substrate and the second substrate together.

Embodiment 76 is the method of embodiment 74 or embodiment 75, further comprising allowing the mixture to cure for at least 12 hours at ambient temperature to form an adhesive adhering the first substrate and the second substrate together.

Embodiment 77 is the method of embodiment 75 or embodiment 76, wherein the adhesive exhibits a minimum overlap shear on aluminum of 0.3 megaPascals (MPa).

Embodiment 78 is the method of any of embodiments 74 to 77, where the combining is performed on the first major surface of the first substrate.

Embodiment 79 is the method of any of embodiments 74 to 78, wherein the disposing comprises spreading the mixture on the first major surface of the first substrate.

Embodiment 80 is a method of making a two-part composition, the method comprising:
(a) providing a first part by forming a polymeric material of any of embodiments 1 to 51; and
(b) providing a second part comprising at least one amine, at least one molecule of the at least one amine having an average amine functionality of 2.0 or greater, wherein each amine is a primary amine or a secondary amine.

Embodiment 81 is the method of embodiment 80, wherein at least one molecule of the at least one amine has an average amine functionality of 3.0 or greater.

Embodiment 82 is the method of embodiment 80 or embodiment 81, wherein the at least one amine has an average amine functionality of 2.4 or greater.

Embodiment 83 is the method of any embodiments 80 to 82, wherein the at least one amine comprises a primary amine comprising a phenalkamine, 4,7,10-trioxatridecane-1,13-diamine, a reaction product of epichlorohydrin with 1,3-benzenedimethanamine, or combinations thereof.

Embodiment 84 is the method of any embodiments 80 to 83, wherein the at least one amine comprises a triamine.

Embodiment 85 is the method of any of embodiments 80 to 84, wherein the at least one amine comprises an amine-terminated polyether.

Embodiment 86 is the method of any of embodiments 80 to 85, wherein the at least one amine comprises a difunctional or trifunctional amine-terminated polyether

Embodiment 87 is the method of any of embodiments 80 to 86, wherein the at least one amine comprises a reaction product of epichlorohydrin with 1,3-benzenedimethanamine.

Embodiment 88 is the method of any of embodiments 80 to 87, wherein the at least one amine comprises a molecular weight of 2,000 grams per mole or less.

### Examples

Unless otherwise noted or readily apparent from the context, all parts, percentages, ratios, etc. in the Examples and the rest of the specification are by weight. Table 1, below, lists materials used in the examples and their sources.

TABLE 1
Materials List

| DESIGNATION | DESCRIPTION | SOURCE |
|---|---|---|
| DN3400 | HDI-based oligomer with uretdione | Covestro, |
| | functional groups obtained as DESMODUR | Leverkusen, |
| | N3400 | Germany |
| 2-ethyl hexanol | 2-ethylhexanol | Alfa Aesar, |
| | | Haverhill, Massachusetts |
| 2-Butanol | 2-Butanol | Alfa Aesar |
| 1,3-BD | 1,3-butanediol | Alfa Aesar |
| NPG | 2,2-dimethyl-1,3-propanediol | Alfa Aesar |
| BiND | bismuth neodecanoate | Gelest, Morrisville, |
| | | Pennsylvania |
| T650 | Poly(tetramethylene ether) glycol with a | Invista |
| | molecular weight of 650 g/mol obtained | |
| | under the trade designation TERATHANE | |
| | 650 | |
| DBU | 1,8-Diazabicyclo[5.4.0]undec-7-ene | Alfa Aesar |
| Calcium Triflate | Calcium trifluoromethanesulfonate | 3M Company, St. Paul, |
| | | Minnesota |
| EGS110 | Glycidyl ester of neodecanoic acid obtained | Emerald Performance |
| | under the trade designation ERISYS GS-110 | Materials, Vancouver, |
| | | Washington |
| EGE6 | 2-Ethylhexyl glycidyl ether obtained under | Emerald Performance |
| | the trade designation ERISYS GE-6 | Materials |
| EGE21 | 1,4-butanediol diglycidyl ether obtained | Emerald Performance |
| | under the trade designation ERISYS GE-21 | Materials |
| EGE20 | Neopentyl glycol diglycidyl ether obtained | Emerald Performance |
| | under the trade designation ERISYS GE-20 | Materials |
| H505 | Castor oil polyglycidyl ether obtained under | Hexion Inc. |
| | the trade designation HELOXY 505 | |
| EGE31 | Triglycidyl ether of trimethylolethane | Emerald Performance |
| | obtained under the trade designation | Materials |
| | ERISYS GE-31 | |
| EGA240 | Tetrafunctional epoxy resin based on meta- | Emerald Performance |
| | Xylenediamine obtained under the trade | Materials |
| | designation ERISYS GA-240 | |
| EPON 828 | BPA Epoxy solution obtained under the | Hexion Inc. |
| | trade designation EPON 828 | |
| EPON SU-2.5 | An epoxy bisphenol A novolac resin | Hexion Inc. |
| | obtained under the trade designation | |
| | EPON ™ SU-2.5 | |
| EPON 862 | Diglycidyl Ether of Bisphenol F is a low | Hexion Inc. |
| | viscosity, liquid epoxy resin manufactured | |
| | from epichlorohydrin and Bisphenol-F | |
| | obtained under the trade designation | |
| | EPON ™ Resin 862 | |
| Epoxy-Mix | Epoxy mixture of equal weight percent | |
| | (wt. %) of EGE31, EGE6, EGE21, EGS110, | |
| | and H505, and 86 wt. % EPON 828 | |
| JT403 | Trifunctional amine-terminated polyether | Huntsman Corporation, |
| | obtained under the trade designation | The Woodlands, Texas |
| | JEFFAMINE T-403 Polyetheramine | |
| JD230 | Difunctional amine-terminated polyether | Huntsman Corporation |
| | obtained under the trade designation | |
| | JEFFAMINE D230 | |
| G328 | 1,3-benzenedimethanamine; reaction | Mitsubishi Gas Chemical |
| | products with epichlorohydrin, obtained | Company, New York, New |
| | under the trade designation GASKAMINE | York |
| | 328 | |
| G240 | Reaction product between m- | Mitsubishi Gas Chemical |
| | xylylenediamine and styrene; obtained under | Company |
| | the trade designation GASKAMINE 240 | |
| C5607 | Solvent-free phenalkamine obtained under | Cardolite Corporation, |
| | the trade designation CARDOLITE 5607 | Monmouth Junction, New |
| | | Jersey |
| TTD | 4,7,10-Trioxatridecane-1,13-diamine | Sigma-Aldrich |
| A350A | Ancamide 350A, Standard reactive liquid | Evonik Industries, Essen, |
| | polyamide. Possesses low viscosity and high | Germany |
| | imidazoline content. | |
| FR 44 | Poly(butylene adipate) diol obtained under | Lanxess, Cologne, |
| | the trade designation FOMREZ 44-111 | Germany |

### Test Methods

### Overlap Shear Test Method

The performance of adhesives derived from uretdione-containing polymeric material was determined using overlap shear tests. Aluminum coupons (25 millimeter (mm)×102 mm×1.6 mm) were sanded with 220 grit sandpaper and wiped with isopropanol and dried. The uretdione-containing polymeric material and the amine curative were each added to a plastic cup and mixed at 2700-3500 revolutions per minute (RPM) for 45 seconds to 90 seconds using a speed mixer (DAC 150 FV SpeedMixer from FlackTek, Landrum, S.C.). Catalyst (if used) were then added, and the mixture was mixed for 15 to 30 seconds using a combination of hand mixing with a wood applicator stick and the speed mixer at 2700-3500 RPM.

The mixture was then applied to a 25 mm×13 mm area on one end of the aluminum coupon, and two pieces of stainless steel wire (0.25 mm diameter) were placed in the resin to act as bondline spacers. One end of a second aluminum coupon was then pressed into to the mixture to produce an overlap of approximately 13 mm. A binder clip was placed on the sample, and it was allowed to cure for at least 18 hours. The samples were tested to failure in shear mode at a rate of 2.54 mm/minute using a tensile load frame with self-tightening grips (MTS Systems, Eden Prairie, Minn.). After failure, the length of the overlap area was measured. The overlap shear value was then calculated by dividing the peak load by the overlap area.

### FTIR Characterization

The infrared (IR) spectra of the polymeric material samples and the cured adhesives were obtained using an infrared Fourier Transform spectrometer (NICOLET 6700 FTIR Spectrometer, Thermo Scientific, Madison, Wis.) equipped with a Smart iTR Diamond Attenuated Total Reflectance (ATR) accessory. For all the polymeric materials the isocyanate peak at 2260 cm⁻¹ was not present in the infrared spectrum, indicating that the isocyanate had reacted completely with the alcohols during the preparation of the polymeric materials. For all the polymeric materials, a strong uretdione signal at 1760 cm⁻¹ was observed. For all the cured adhesives, the uretdione signal at 1760 cm⁻¹ had nearly disappeared, indicating reaction of the uretdione group during the cure of the adhesives.

### NMR Analysis of DN3400

DN3400 was dissolved in deuterated dimethyl sulfoxide (DMSO) solvent. The ¹H proton spectrum was taken with a 500 MHz NMR (AVANCE III 500 MHz spectrometer equipped with a broadband cryoprobe from Bruker, Billerica, Mass.). The resulting spectrum had 5 major signals. Signals at 1.31 parts per million (ppm) and 1.55 ppm were attributed to methylene groups at the 3 and 4 positions and the 2 and 5 positions of the HDI derivatives, respectively. A signal at 3.17 ppm was attributed to methylene protons adjacent to a uretdione group. A signal at 3.34 ppm was attributed to methylene protons adjacent to an isocyanate group. A signal at 3.74 ppm was attributed to methylene protons adjacent to an isocyanurate group. The integrations of these three methylene signals were 1.35, 1.79, and 0.49, respectively. The published values for DN3400 are an equivalent weight of isocyanate of 193 g/equivalent and 22 weight percent isocyanate. The ratio of the integration of the signal at 3.17 ppm over the integration of the signal at 3.34 ppm is 0.75, which corresponds to 16 wt. % uretdione. The ratio of the integration of the signal at 3.74 ppm over the integration of the signal at 3.34 ppm is 0.27, which corresponds to 3 wt. % isocyanurate. The functionality of DN3400 is published as 2.5 (in “Raw Materials for Automotive Refinish Systems” from Bayer Materials Science, 2005), so the average molecular weight of the molecule in DN3400 is 193 grams/equivalent×2.5 equivalents/mole=482 grams/mol. For every 2.5 isocyanate methylene groups, there are 0.75*2.5=1.875 uretdione methylene groups. There are two methylene groups per uretdione group, so there are about 0.94 uretdione groups per molecule of DN3400.

### Calculation of Uretdione Functionality in Polymeric Materials

A modified Carothers equation relates degree of polymerization (DP) to the average functionality (fav) and conversion (p) in a step growth polymerization [Carothers, Wallace (1936). “Polymers and Polyfunctionality”. Transactions of the Faraday Society. 32: 39-49]:

DP=2/(2−(p*fav))

This equation can be used to calculate the average degree of polymerization of each polymerized reaction product. Based on the degree of polymerization, the average number of uretdione groups in the polymerized reaction product (fUD) can be calculated by:

fUD=DP*(DN3400 molecules)*(uretdione groups per DN3400 molecule)/(total molecules)

where the values for “DN3400 molecules” and the “total molecules” correspond to the respective moles of molecules used to make the polymerized reaction product, and the value for “uretdione groups per DN3400 molecule” is 0.94, as calculated based on the NMR data (above). It is shown below that polymerized reaction products with an average uretdione functionality between 0.94<(fUD)<5 in combination with a diluent produce reasonably good properties when cured.

### General Polymerized Reaction Product Preparation

Bismuth neodecanoate, DN3400, the chain extender, and the capping group, and epoxy (when applicable) were added to a glass jar according to Tables 2, 3, 4 and 5. The amounts of alcohol that were added correspond to the equivalent values in Tables 2, 3, 4 and 5 (relative to the equivalents of isocyanate). The mixture was stirred magnetically at 700 RPM. Initially the mixture was hazy, and after about one minute, the mixture became clear and slightly warm. The mixture then continued to exotherm noticeably. Stirring was continued for a total of 5 minutes, and the polymerized reaction product was then allowed to cool to room temperature.

The composition and calculated uretdione functionality of each formulation are reported in Tables 2, 3, 4, and 5.

The mixtures were then tested for overlap shear (OLS) according to the Overlap Shear Test Method described above. Overlap shear test results are reported in Tables 6 and 7 for the various formulations tested.

TABLE 2
Polymerized Reaction Product Formulations

| | | | | | | | | | Calculated |
|---|---|---|---|---|---|---|---|---|---|
| | Capping Group | | | Chain Extender | | | | | Uretdione |
| | | | Relative | | | Relative | DN3400 | BiND | Functionality, |
| Sample | Type | g | equiv. | Type | g | equiv. | g | g | fUD |
| EX-1A | 2-Butanol | 0.90 | 0.63 | NPG | 0.37 | 0.37 | 3.72 | 0.01 | 1.74 |
| EX-1B | 2-Butanol | 21.3 | 0.75 | NPG | 4.98 | 0.25 | 73.88 | 0.20 | 1.37 |
| EX-1C | 2-Butanol | 12.5 | 0.59 | FR 44 | 41.3 | 0.41 | 55.4 | 0.15 | 1.94 |
| EX-1D | 2-Butanol | 13.9 | 0.65 | FR 44 | 35.0 | 0.35 | 55.4 | 0.15 | 1.67 |

N/A = not applicable.

TABLE 3
Polymerized Reaction Product Formulations

| | | | | | | | | | | | | Calculated |
|---|---|---|---|---|---|---|---|---|---|---|---|---|
| | Capping Group | | | Chain Extender 1 | | | Chain Extender 2 | | | | | Uretdione |
| | | | Relative | | | Relative | | | Relative | DN340 | BiND | Functionality, |
| Sample | Type | g | equiv. | Type | g | equiv. | Type | g | equiv. | g | g | fUD |
| EX-2A | 2-Butanol | 0.64 | 0.74 | NPG | 0.075 | 0.14 | 1,3-BD | 0.065 | 0.12 | 2.22 | 0.006 | 1.37 |
| EX-2B | 2-Butanol | 0.64 | 0.73 | NPG | 0.11 | 0.21 | 1,3-BD | 0.032 | 0.06 | 2.22 | 0.006 | 1.37 |
| EX-2C | 2-Butanol | 12.3 | 0.58 | NPG | 5.01 | 0.34 | THF | 8.00 | 0.09 | 55.4 | 0.15 | 1.99 |
| | | | | | | | 650 | | | | | |

TABLE 4
Polymerized Reaction Product Formulations

| | | | | | | | | | | | | Calculated |
|---|---|---|---|---|---|---|---|---|---|---|---|---|
| | Capping Group 1 | | | Capping Group 2 | | | Chain Extender | | | | | Uretdione |
| | | | Relative | | | Relative | | | Relative | DN3400 | BiND | Functionality, |
| Sample | Type | g | equiv. | Type | g | equiv. | Type | g | equiv. | g | g | fUD |
| EX-3A | 2- | 10.64 | 0.38 | 2-Ethyl | 18.67 | 0.38 | NPG | 4.98 | 0.25 | 73.88 | 0.2 | 1.37 |
| | Butanol | | | Hexanol | | | | | | | | |
| EX-3B | 2- | 15.96 | 0.56 | 2-Ethyl | 9.34 | 0.19 | NPG | 4.98 | 0.25 | 73.88 | 0.2 | 1.37 |
| | Butanol | | | Hexanol | | | | | | | | |

TABLE 5
Polymerized Reaction Product Formulations

| | | | | | | | | | | | Calculated |
|---|---|---|---|---|---|---|---|---|---|---|---|
| | Capping Group | | | Chain Extender | | | | | | | Uretdione |
| | | | Relative | | | Relative | Epoxy | | DN3400 | BiND | Functionality, |
| Sample | Type | g | equiv. | Type | g | equiv. | Type | g | g | g | fUD |
| EX-4A | 2-Butanol | 4.52 | 0.63 | NPG | 1.84 | 0.37 | EGE | 2.78 | 18.59 | 0.05 | 1.74 |
| | | | | | | | 31 | | | | |
| EX-4B | 2-Butanol | 3.27 | 0.45 | NPG | 2.80 | 0.55 | EGE | 2.78 | 18.88 | 0.05 | 3.00 |
| | | | | | | | 20 | | | | |

TABLE 6
Evaluation of Amine Equivalents on Adhesive Performance

| | | | | | | | | (Uretdione + | | |
|---|---|---|---|---|---|---|---|---|---|---|
| | Polymerized | | | | | | | Epoxy Equiv.)/ | | |
| | Reaction | | Epoxy | | | | | Amine | | |
| | Product | | | | Wt. % | Amine | | Hydrogen | OLS, psi (MPa) | |
| Sample | Type | g | Type | g | Epoxy** | Type | g | Equiv. | Average | St. Dev. |
| EX-5 | EX-2C | 0.25 | EPON | 1.00 | 80 | JT403 | 2.28 | 0.20 | | Did not form |
| | | | 828 | | | | | | | bond adequate |
| | | | | | | | | | | to test |
| EX-6 | EX-2C | 0.25 | EPON | 1.00 | 80 | JT403 | 1.31 | 0.35 | 181.9 | 178.6 (1.23) |
| | | | 828 | | | | | | (1.25) | |
| EX-7 | EX-2C | 0.25 | EPON | 1.00 | 80 | JT403 | 0.92 | 0.50 | 1531.1 | 496.3 (3.42) |
| | | | 828 | | | | | | (10.56) | |
| EX-8 | EX-2C | 0.25 | EPON | 1.00 | 80 | JT403 | 0.61 | 0.75 | 1612.1 | 515.1 (3.55) |
| | | | 828 | | | | | | (11.12) | |
| EX-9 | EX-2C | 0.25 | EPON | 1.00 | 80 | JT403 | 0.51 | 0.90 | 1160.3 | 496.9 (3.43) |
| | | | 828 | | | | | | (8.0) | |
| EX-10 | EX-2C | 0.25 | EPON | 1.00 | 80 | JT403 | 0.46 | 1.00 | 1799.2 | 546.9 (3.77) |
| | | | 828 | | | | | | (12.41) | |
| EX-11 | EX-2C | 0.25 | EPON | 1.00 | 80 | JT403 | 0.37 | 1.25 | >2160.0 | — |
| | | | 828 | | | | | | (>14.8) | |
| EX-12 | EX-2C | 0.25 | EPON | 1.00 | 80 | JT403 | 0.31 | 1.50 | 838.7 | 18.7 (0.13) |
| | | | 828 | | | | | | (5.78) | |
| EX-13 | EX-2C | 0.25 | EPON | 1.00 | 80 | JT403 | 0.23 | 2.00 | 557.3 | 152.2 (1.05) |
| | | | 828 | | | | | | (3.84) | |
| EX-14 | EX-2C | 0.25 | EPON | 1.00 | 80 | JT403 | 0.15 | 3.00 | 42.7 | 11.5 (0.08) |
| | | | 828 | | | | | | (0.29) | |
| EX-15 | EX-2C | 1.00 | EPON | 1.00 | 50 | JT403 | 1.79 | 0.30 | 159.7 | 91.7 (0.63) |
| | | | 828 | | | | | | (1.10) | |
| EX-16 | EX-2C | 1.00 | EPON | 1.00 | 50 | JT403 | 1.07 | 0.50 | 481.4 | 224.3 (1.55) |
| | | | 828 | | | | | | (3.32) | |
| EX-17 | EX-2C | 1.00 | EPON | 1.00 | 50 | JT403 | 0.54 | 1.00 | 463.6 | 207 (1.43) |
| | | | 828 | | | | | | (3.20) | |
| EX-18 | EX-2C | 1.00 | EPON | 1.00 | 50 | JT403 | 0.36 | 1.50 | 228.2 | 181.3 (1.25) |
| | | | 828 | | | | | | (1.57) | |
| EX-19 | EX-2C | 1.00 | EPON | 1.00 | 50 | JT403 | 0.27 | 2.00 | 140.6 | 81.4 (0.56) |
| | | | 828 | | | | | | (0.97) | |
| EX-20 | EX-2C | 1.00 | EPON | 1.00 | 50 | JT403 | 0.22 | 2.50 | 111.7 | 65.3 (0.45) |
| | | | 828 | | | | | | (0.77) | |
| EX-21 | EX-2C | 1.00 | EPON | 1.00 | 50 | JT403 | 0.18 | 3.00 | 74.9 | 37.8 (0.26) |
| | | | 828 | | | | | | (0.52) | |
| EX-22 | EX-2C | 1.00 | EPON | 0.54 | 35 | JT403 | 1.13 | 0.30 | 140.8 | 46 (0.32) |
| | | | 828 | | | | | | (0.97) | |
| EX-23 | EX-2C | 1.00 | EPON | 0.54 | 35 | JT403 | 0.68 | 0.50 | 1133 | 112.7 (0.78) |
| | | | 828 | | | | | | (7.81) | |
| EX-24 | EX-2C | 1.00 | EPON | 0.54 | 35 | JT403 | 0.45 | 0.75 | 1224.9 | 131.4 (0.91) |
| | | | 828 | | | | | | (8.45) | |
| EX-25 | EX-2C | 1.00 | EPON | 0.54 | 35 | JT403 | 0.38 | 0.90 | 753.8 | 76.8 (0.53) |
| | | | 828 | | | | | | (5.20) | |
| EX-26 | EX-2C | 1.00 | EPON | 0.54 | 35 | JT403 | 0.34 | 1.00 | 153 | 51.5 (0.36) |
| | | | 828 | | | | | | (1.05) | |
| EX-27 | EX-2C | 1.00 | EPON | 0.54 | 35 | JT403 | 0.27 | 1.25 | 162.7 | — |
| | | | 828 | | | | | | (1.12) | |
| EX-28 | EX-2C | 1.00 | EPON | 0.54 | 35 | JT403 | 0.23 | 1.50 | 105.3 | 15.2 (0.10) |
| | | | 828 | | | | | | (0.73) | |
| EX-29 | EX-2C | 1.00 | EPON | 1.00 | 50 | C5607 | 2.10 | 0.30 | 289 | 154.1 (1.06) |
| | | | 828 | | | | | | (1.99) | |
| EX-30 | EX-2C | 1.00 | EPON | 1.00 | 50 | C5607 | 0.90 | 0.70 | 1247.5 | 296.4 (2.04) |
| | | | 828 | | | | | | (8.60) | |
| EX-31 | EX-2C | 1.00 | EPON | 1.00 | 50 | C5607 | 0.63 | 1.00 | 1795 | 131.8 (0.91) |
| | | | 828 | | | | | | (12.38) | |
| EX-32 | EX-2C | 1.00 | EPON | 1.00 | 50 | C5607 | 0.42 | 1.50 | 481.2 | 47.3 (0.33) |
| | | | 828 | | | | | | (3.32) | |
| EX-33 | EX-2C | 1.00 | EPON | 1.00 | 50 | C5607 | 0.32 | 2.00 | 116.2 | 9.7 (0.07) |
| | | | 828 | | | | | | (0.80) | |
| EX-34 | EX-2C | 1.00 | EPON | 1.00 | 50 | C5607 | 0.21 | 3.00 | 40.9 | 6.7 (0.05) |
| | | | 828 | | | | | | (0.28) | |
| EX-35 | EX-2C | 1.00 | EPON | 0.54 | 35 | C5607 | 1.32 | 0.30 | 373.4 | 106.9 (0.74) |
| | | | 828 | | | | | | (2.57) | |
| EX-36 | EX-2C | 1.00 | EPON | 0.54 | 35 | C5607 | 0.79 | 0.50 | 1920.5 | 338.1 (2.33) |
| | | | 828 | | | | | | (13.24) | |
| EX-37 | EX-2C | 1.00 | EPON | 0.54 | 35 | C5607 | 0.53 | 0.75 | 994.7 | 225.6 (1.56) |
| | | | 828 | | | | | | (6.86) | |
| EX-38 | EX-2C | 1.00 | EPON | 0.54 | 35 | C5607 | 0.44 | 0.90 | 910 | 499.5 (3.44) |
| | | | 828 | | | | | | (6.27) | |
| EX-39 | EX-2C | 1.00 | EPON | 0.54 | 35 | C5607 | 0.40 | 1.00 | 1406.8 | 232.9 (1.61) |
| | | | 828 | | | | | | (9.70) | |
| EX-40 | EX-2C | 1.00 | EPON | 0.54 | 35 | C5607 | 0.32 | 1.25 | 948.8 | 779.5 (5.37) |
| | | | 828 | | | | | | (6.54) | |
| EX-41 | EX-2C | 1.00 | EPON | 0.54 | 35 | C5607 | 0.26 | 1.50 | 167.4 | — |
| | | | 828 | | | | | | (1.15) | |
| EX-42 | EX-2C | 1.00 | EPON | 0.54 | 35 | C5607 | 0.20 | 2.00 | 59.6 | 57.2 (0.39) |
| | | | 828 | | | | | | (0.41) | |
| EX-43 | EX-2C | 1.00 | EPON | 0.54 | 35 | C5607 | 0.16 | 2.50 | 13.5 | 0.7 (0.005) |
| | | | 828 | | | | | | (0.09) | |
| EX-44 | EX-2C | 0.25 | EPON | 1.00 | 80 | C5607 | 3.58 | 0.15 | | Did not form |
| | | | 828 | | | | | | | bond adequate |
| | | | | | | | | | | to test |
| EX-45 | EX-2C | 0.25 | EPON | 1.00 | 80 | C5607 | 1.79 | 0.30 | 571.4 | 326.2 (2.25) |
| | | | 828 | | | | | | (3.94) | |
| EX-46 | EX-2C | 0.25 | EPON | 1.00 | 80 | C5607 | 1.07 | 0.50 | 854.2 | 299.3 (2.06) |
| | | | 828 | | | | | | (5.89) | |
| EX-47 | EX-2C | 0.25 | EPON | 1.00 | 80 | C5607 | 0.71 | 0.75 | 836.5 | 330.4 (2.28) |
| | | | 828 | | | | | | (5.77) | |
| EX-48 | EX-2C | 0.25 | EPON | 1.00 | 80 | C5607 | 0.60 | 0.90 | 807.4 | 195.1 (1.35) |
| | | | 828 | | | | | | (5.57) | |
| EX-49 | EX-2C | 0.25 | EPON | 1.00 | 80 | C5607 | 0.54 | 1.00 | 768.9 | 59.6 (0.41) |
| | | | 828 | | | | | | (5.3) | |
| EX-50 | EX-2C | 0.25 | EPON | 1.00 | 80 | C5607 | 0.43 | 1.25 | 754.1 | 128.6 (0.89) |
| | | | 828 | | | | | | (5.2) | |
| EX-51 | EX-2C | 0.25 | EPON | 1.00 | 80 | C5607 | 0.36 | 1.50 | 829.4 | 487.8 (3.36) |
| | | | 828 | | | | | | (5.72) | |
| EX-52 | EX-2C | 0.25 | EPON | 1.00 | 80 | C5607 | 0.27 | 2.00 | 787.3 | 297.1 (2.05) |
| | | | 828 | | | | | | (5.43) | |
| EX-53 | EX-2C | 0.25 | EPON | 1.00 | 80 | C5607 | 0.21 | 2.50 | 562.3 | 428 (2.95) |
| | | | 828 | | | | | | (3.88) | |
| EX-54 | EX-2C | 0.25 | EPON | 1.00 | 80 | C5607 | 0.18 | 3.00 | 283.7 | 177.8 (1.23) |
| | | | 828 | | | | | | (1.96) | |
| EX-55 | EX-2C | 0.25 | EPON | 1.00 | 80 | C5607 | 0.13 | 4.00 | 23.6 | 0.7 (0.005) |
| | | | 828 | | | | | | (0.16) | |
| EX-56 | EX-1A | 1.00 | EPON | 1.00 | 50 | G240 | 6.89 | 0.10 | — | Did not form |
| | | | 828 | | | | | | | bond adequate |
| | | | | | | | | | | to test |
| EX-57 | EX-1A | 1.00 | EPON | 1.00 | 50 | G240 | 3.46 | 0.20 | — | Did not form |
| | | | 828 | | | | | | | bond adequate |
| | | | | | | | | | | to test |
| EX-58 | EX-1A | 1.00 | EPON | 1.00 | 50 | G240 | 1.74 | 0.40 | 58.2 | — |
| | | | 828 | | | | | | (0.40) | |
| EX-59 | EX-1A | 1.00 | EPON | 1.00 | 50 | G240 | 0.99 | 0.70 | 1434 | 60.3 (0.42) |
| | | | 828 | | | | | | (9.89) | |
| EX-60 | EX-1A | 1.00 | EPON | 1.00 | 50 | G240 | 0.69 | 1.00 | 891.3 | 68.8 (0.47) |
| | | | 828 | | | | | | (6.15) | |
| EX-61 | EX-1A | 1.00 | EPON | 1.00 | 50 | G240 | 0.35 | 2.00 | 38.7 | 19.1 (0.13) |
| | | | 828 | | | | | | (0.27) | |
| EX-62 | EX-1A | 1.00 | EPON | 1.00 | 50 | G240 | 0.23 | 3.00 | — | Did not form |
| | | | 828 | | | | | | | bond adequate |
| | | | | | | | | | | to test |
| EX-63 | EX-1A | 0.30 | EPON | 0.70 | 70 | G240 | 4.26 | 0.10 | — | Did not form |
| | | | 828 | | | | | | | bond adequate |
| | | | | | | | | | | to test |
| EX-64 | EX-1A | 0.30 | EPON | 0.70 | 70 | G240 | 1.07 | 0.40 | 33.5 | 26.9 (0.19) |
| | | | 828 | | | | | | (0.23) | |
| EX-65 | EX-1A | 0.30 | EPON | 0.70 | 70 | G240 | 0.53 | 0.80 | 924.6 | — |
| | | | 828 | | | | | | (6.37) | |
| EX-66 | EX-1A | 0.30 | EPON | 0.70 | 70 | G240 | 0.43 | 1.00 | 431 | 157 (1.08) |
| | | | 828 | | | | | | (2.97) | |
| EX-67 | EX-1A | 0.30 | EPON | 0.70 | 70 | G240 | 0.21 | 2.00 | 22.2 | — |
| | | | 828 | | | | | | (0.15) | |
| EX-68 | EX-2C | 1.00 | EPON | 1.000 | 50 | A350A | 6.62 | 0.10 | — | Did not form |
| | | | 828 | | | | | | | bond adequate |
| | | | | | | | | | | to test |
| EX-69 | EX-2C | 1.00 | EPON | 1.00 | 50 | A350A | 3.31 | 0.20 | 114.8 | 22.9 (0.16) |
| | | | 828 | | | | | | (0.79) | |
| EX-70 | EX-2C | 1.00 | EPON | 1.00 | 50 | A350A | 2.21 | 0.30 | 1444.7 | 375.3 (2.59) |
| | | | 828 | | | | | | (9.96) | |
| EX-71 | EX-2C | 1.00 | EPON | 1.00 | 50 | A350A | 1.11 | 0.60 | 1123.5 | — |
| | | | 828 | | | | | | (7.75) | |
| EX-72 | EX-2C | 1.00 | EPON | 1.00 | 50 | A350A | 0.33 | 2.00 | 152 | 31.1 (0.21) |
| | | | 828 | | | | | | (1.05) | |
| EX-73 | EX-2C | 1.00 | EPON | 1.00 | 50 | A350A | 0.22 | 3.00 | 130.9 | 10.1 (0.07) |
| | | | 828 | | | | | | (0.90) | |
| EX-74 | EX-2C | 0.25 | EPON | 1.00 | 80 | A350A | 5.63 | 0.10 | — | Did not form |
| | | | 828 | | | | | | | bond adequate |
| | | | | | | | | | | to test |
| EX-75 | EX-2C | 0.25 | EPON | 1.00 | 80 | A350A | 2.81 | 0.20 | 311.2 | — |
| | | | 828 | | | | | | (2.15) | |
| EX-76 | EX-2C | 0.25 | EPON | 1.00 | 80 | A350A | 1.88 | 0.30 | 1599.4 | 55.1 (0.38) |
| | | | 828 | | | | | | (11.03) | |
| EX-77 | EX-2C | 0.25 | EPON | 1.00 | 80 | A350A | 0.94 | 0.60 | 1908.3 | 444.5 (3.06) |
| | | | 828 | | | | | | (13.16) | |
| EX-78 | EX-2C | 0.25 | EPON | 1.00 | 80 | A350A | 0.57 | 1.00 | >2260 | — |
| | | | 828 | | | | | | (>15.58) | |
| EX-79 | EX-2C | 0.25 | EPON | 1.00 | 80 | A350A | 0.38 | 1.50 | 549.7 | 138 (0.95) |
| | | | 828 | | | | | | (3.79) | |
| EX-80 | EX-2C | 0.25 | EPON | 1.00 | 80 | A350A | 0.28 | 2.00 | 176.6 | 53.2 (0.37) |
| | | | 828 | | | | | | (1.22) | |
| EX-81 | EX-2C | 0.25 | EPON | 1.00 | 80 | A350A | 0.23 | 2.50 | 189.7 | 25 (0.17) |
| | | | 828 | | | | | | (1.31) | |
| EX-82 | EX-2C | 0.25 | EPON | 1.00 | 80 | A350A | 0.19 | 3.00 | 106.7 | 65.2 (0.45) |
| | | | 828 | | | | | | (0.74) | |

**Relative to Uretdione-Containing Polymerized Reaction Product

TABLE 7
Adhesive Evaluation

| | Polymerized | | Epoxy | | | | | OLS, psi (MPa) | |
|---|---|---|---|---|---|---|---|---|---|
| | Reaction Product | | | | Wt. % | Amine | | | St. |
| Sample | Type | g | Type | g | Epoxy*** | Type | g | Average | Dev. |
| EX-83 | EX-1A | 1.00 | EPON | 1.00 | 50 | JT403 | 1.20 | 2069 | 647 |
| | | | 828 | | | | | (14.27) | (4.46) |
| EX-84 | EX-1A | 1.00 | EPON | 3.00 | 75 | JT403 | 3.09 | 3078 | 62 |
| | | | 828 | | | | | (21.22) | (0.43) |
| EX-85 | EX-1A | 0.10 | EPON | 0.90 | 90 | JT403 | 0.88 | 1508 | 41.5 |
| | | | 828 | | | | | (10.40) | (0.29) |
| EX-86 | EX-1B | 1.00 | EGA240 | 1.00 | 50 | JT403 | 1.99 | 429 | 8 |
| | | | | | | | | (2.96) | (0.06) |
| EX-87 | EX-1B | 1.00 | EGA240 | 3.00 | 75 | JT403 | 5.45 | 505 | 58.5 |
| | | | | | | | | (3.48) | (0.40) |
| EX-88 | EX-1B | 0.10 | EGA240 | 0.90 | 90 | JT403 | 1.59 | 596 | 31 |
| | | | | | | | | (4.11) | (0.21) |
| EX-89 | EX-1A | 1.00 | EGE31 | 0.67 | 40 | JT403 | 0.99 | 330.3 | 40.8 |
| | | | | | | | | (2.28) | (0.28) |
| EX-90 | EX-2A | 1.00 | EPON | 1.00 | 50 | TTD | 0.49 | 1775.7 | 264.6 |
| | | | 828 | | | | | (12.24) | (1.82) |
| EX-91 | EX-3A | 1.00 | EPON | 1.00 | 50 | TTD | 0.49 | 1803.5 | 113.1 |
| | | | 828 | | | | | (12.43) | (0.78) |
| EX-92 | EX-2B | 1.00 | EPON | 3.00 | 75 | TTD | 1.06 | 699 | 460.8 |
| | | | 828 | | | | | (4.82) | (3.18) |
| EX-93 | EX-3B | 1.00 | EPON | 3.00 | 75 | TTD | 1.06 | 1153.2 | 241.5 |
| | | | 828 | | | | | (7.95) | (1.67) |
| EX-94 | EX-4A | 1.00 | EPON | 0.90 | 53 | JT403 | 0.60 | 1526.8 | 174.3 |
| | | | 828 | | | | | (10.53) | (1.20) |
| EX-95 | EX-4B | 1.00 | EPON | 0.90 | 53 | JT403 | 0.62 | 1100 | 282.8 |
| | | | 828 | | | | | (7.58) | (1.95) |
| EX-96 | EX-1B | 1.00 | EPON | 1.00 | 50 | JT403 | 0.61 | 1614.8 | 307.2 |
| | | | SU-2.5 | | | | | (11.13) | (2.12) |
| EX-97 | EX-1B | 1.00 | EPON | 1.00 | 50 | JT403 | 0.65 | 1985.6 | 90.4 |
| | | | 862 | | | | | (13.69) | (0.62) |
| EX-98 | EX-1C | 1.00 | EPON | 1.00 | 50 | JD230 | 0.47 | 1084.3 | 69.7 |
| | | | 828 | | | | | (7.48) | (0.48) |
| EX-99 | EX-1D | 0.33 | EPON | 1.00 | 75 | G328 | 1.03 | 1193.7 | 335.2 |
| | | | 828 | | | | | (8.23) | (2.31) |
| EX-100 | EX-2C | 0.93 | Epoxy- | 1.07 | 54 | JT403 | 0.535 | 839.5 | 33.2 |
| | | | Mix | | | | | (5.79) | (0.23) |

*With 0.080 g of CaOTf;
**With 0.19 g of DBU
***Relative to Uretdione-Containing Polymerized Reaction Product

Other modifications and variations to the present disclosure may be practiced by those of ordinary skill in the art, without departing from the spirit and scope of the present disclosure, which is more particularly set forth in the appended claims. It is understood that aspects of the various embodiments may be interchanged in whole or part or combined with other aspects of the various embodiments. All cited references, patents, or patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A polymeric material comprising:
a polymerized reaction product of a polymerizable composition comprising components, the components comprising:
(a) a uretdione-containing material comprising a reaction product of a diisocyanate reacted with itself;
(b) a first hydroxyl-containing compound having more than one OH group;
(c) an optional second hydroxyl-containing compound having a single OH group, wherein the second hydroxyl-containing compound is a primary alcohol or a secondary alcohol; and
(d) an epoxy component in an amount of 35% by weight or greater, based on the total weight of the polymerizable composition;
wherein the polymeric material comprises a solids content of 90% or greater and exhibits a dynamic viscosity of 10 Poise (P) to 10,000 P, inclusive, as determined using a Brookfield viscometer.

2. The polymeric material of claim 1, wherein components (a), (b), and, if present, (c), are reacted, and then component (d) is combined with the reaction product of components (a), (b), and, if present, (c).

3. The polymeric material of claim 1, wherein component (d) is present at the time of reaction of components (a), (b), and, if present, (c).

4. The polymeric material of claim 1, wherein the second hydroxyl-containing compound is present and is an alkyl alcohol, a polyester alcohol, or a polyether alcohol.

5. The polymeric material of claim 1, wherein the first hydroxyl-containing compound is an alkylene polyol, a polyester polyol, or a polyether polyol.

6. The polymeric material of claim 1, wherein the uretdione-containing material comprises a compound of Formula I: 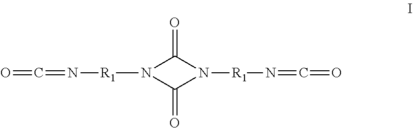
wherein R₁ is independently a C₄ to C₁₄ alkylene, arylene, and alkaralyene.

7. The polymeric material of claim 1, wherein the polymeric material is essentially free of isocyanates.

8. The polymeric material of claim 1, wherein the epoxy component comprises at least one multifunctional epoxy.

9. The polymeric material of claim 1, wherein the epoxy component is present in an amount of 35% to 95% by weight, based on the total weight of the polymerizable composition, and wherein the epoxy component comprises a polyglycidyl ether of a polyhydric phenol.

10. The polymeric material of claim 1, wherein the epoxy component is present in an amount of 35% to 95% by weight, based on the total weight of the polymerizable composition, and wherein the epoxy component comprises an epoxidised (poly)olefinic resin, an epoxidised phenolic novolac resin, an epoxidised cresol novolac resin, or a combination thereof.

11. The polymeric material of claim 1, wherein the epoxy component is present in an amount of 50% to 80% by weight or 60% to 75% by weight, based on the total weight of the polymerizable composition.

12. A two-part composition comprising:
(a) a first part comprising a polymeric material comprising:
a polymerized reaction product of a polymerizable composition comprising components, the components comprising:
(i) a uretdione-containing material comprising a reaction product of a diisocyanate reacted with itself;
(ii) a first hydroxyl-containing compound having more than one OH group;
(iii) an optional second hydroxyl-containing compound having a single OH group, wherein the second hydroxyl-containing compound is a primary alcohol or a secondary alcohol;
and
(iv) an epoxy component in an amount of 35% by weight or greater, based on the total weight of the polymerizable composition;
wherein the polymeric material comprises a solids content of 90% or greater; and
(b) a second part comprising at least one amine, at least one molecule of the at least one amine having an average amine functionality of 2.0 or greater, wherein each amine is a primary amine or a secondary amine.

13. The two-part composition of claim 12, wherein at least one molecule of the at least one amine has an average amine functionality of 2.4 or greater.

14. A polymerized product of the two-part composition of claim 12.

15. The polymerized product of claim 14, wherein the polymerized product coats at least a portion of a substrate.

16. A method of adhering two substrates together, the method comprising:
(a) obtaining a two-part composition, the two-part composition comprising:
(i) a first part comprising:
a polymeric material comprising a reaction product of a polymerizable composition comprising components, the components comprising:
(1) a uretdione-containing material comprising a reaction product of a diisocyanate reacted with itself;
(2) a first hydroxyl-containing compound having more than one OH group;
(3) an optional second hydroxyl-containing compound having a single OH group, wherein the second hydroxyl-containing compound is a primary alcohol or a secondary alcohol; and
(4) an epoxy component in an amount of 35% by weight or greater, based on the total weight of the polymerizable composition;
wherein the polymeric material comprises a solids content of 90% or greater; and
(ii) a second part comprising at least one amine, at least one molecule of the at least one amine having an average amine functionality of 2.0 or greater wherein each amine is a primary amine or a secondary amine;
(b) combining at least a portion of the first part with at least a portion of the second part to form a mixture;
(c) disposing at least a portion of the mixture on a first major surface of a first substrate; and
(d) contacting a first major surface of a second substrate with the mixture disposed on the first substrate.

17. The method of claim 16, wherein the adhesive exhibits a minimum overlap shear on aluminum of 0.3 megaPascals (MPa).

18. A method of making a two-part composition, the method comprising:
(a) providing a first part by forming a polymeric material of claim 1; and
(b) providing a second part comprising at least one amine, at least one molecule of the at least one amine having an average amine functionality of 2.0 or greater, wherein each amine is a primary amine or a secondary amine.
